(19) United States
(12) Patent Application Publication
(10) Pub. No.: US 2025/0234396 A1
(43) Pub. Date: Jul. 17, 2025

(54) ELECTRONIC DEVICE FOR CONTROLLING PACKET DATA NETWORK CONNECTION AND OPERATION METHOD THEREFOR

(71) Applicant: Samsung Electronics Co., Ltd., Suwon-si (KR)

(72) Inventors: Jungmin OH, Suwon-si (KR); Sanghyun LEE, Suwon-si (KR)

(21) Appl. No.: 19/098,335

(22) Filed: Apr. 2, 2025

Related U.S. Application Data
(63) Continuation of application No. PCT/KR2023/012925, filed on Aug. 30, 2023.

(30) Foreign Application Priority Data
Oct. 5, 2022 (KR) 10-2022-0127398
Oct. 26, 2022 (KR) 10-2022-0139632

(51) Int. Cl. H04W 76/10; H04L 61/4511; H04L 65/1016; H04W 60/04

(52) U.S. Cl. CPC H04W 76/10; H04L 61/4511; H04L 65/1016; H04W 60/04

(57) ABSTRACT

An electronic device is provided. The electronic device includes a radio frequency (RF) circuit, memory, comprising one or more storage media, storing instructions, and at least one processor communicatively coupled to the RF circuit and the memory, wherein the instructions, when executed by the at least one processor individually or collectively, cause the electronic device to establish a first Internet packet data network (PDN) connection associated with a first subscriber identity module (SIM), and, based on the first Internet PDN connection, perform a registration procedure with a second Internet protocol (IP) multimedia subsystem (IMS) connected to a second communication network, and wherein the first SIM is used for attaching to a first communication network and a second SIM is used for attaching to the second communication network.

### CROSS-REFERENCE TO RELATED APPLICATION(S)

This application is a continuation application, claiming priority under 35 U.S.C. § 365 (c), of an International application No. PCT/KR2023/012925, filed on Aug. 30, 2023, which is based on and claims the benefit of a Korean patent application number 10-2022-0127398, filed on Oct. 5, 2022, in the Korean Intellectual Property Office, and of a Korean patent application number 10-2022-0139632, filed on Oct. 26, 2022, in the Korean Intellectual Property Office, the disclosure of each of which is incorporated by reference herein in its entirety.

### BACKGROUND

### 1. Field

The disclosure relates to an electronic device for controlling a packet data network (PDN) connection and an operating method thereof.

### 2. Description of Related Art

An electronic device (e.g., a user equipment (UE)) may attach to a wireless communication system and use a communication service (e.g., a voice communication service and/or a data communication service) at a predetermined location or while moving. In order to provide the communication service to the electronic device, an authentication operation for the electronic device is required.

In general, a universal integrated circuit card (UICC) is inserted in an electronic device, and an authentication operation is performed between the electronic device and a server of a communication provider (e.g., a mobile network operator (MNO)) via a universal subscriber identity module (USIM) installed inside the UICC. The UICC may be referred to as a “subscriber identity module (SIM) card” in a case of a global system for mobile communications (GSM) scheme, and may be referred to as a “USIM card” in a wideband code division multiple access (WCDMA), long term evolution (LTE), and/or new radio (NR) schemes.

If a user of an electronic device subscribes to a wireless communication service provided by a communication carrier, the communication carrier may provide the user with a UICC (e.g., a SIM card or a USIM card), and the user may insert the UICC provided by the communication carrier into his or her own electronic device. For example, when the UICC is inserted into the electronic device, a USIM application installed in the UICC may be executed, and an authentication operation may be performed between the electronic device and a server of the communication carrier using an international mobile subscriber identity (IMSI) value stored at the UICC and an encryption key value for authentication. If the authentication operation for the electronic device is successful, the wireless communication service may be provided to the electronic device.

An electronic device may support two or more SIMs. An electronic device supporting two SIMs may be referred to as a “dual SIM electronic device.” For example, an electronic device supporting a plurality of SIMs may be referred to as a “multi-SIM electronic device.” The dual SIM electronic device or the multi-SIM electronic device may support the plurality of SIMs, and each of the plurality of SIMs may be associated with unique subscription information.

An electronic device in which one transceiver transmits and receives signals associated with two SIMs may be referred to as a “dual SIM dual standby (DSDS) electronic device.” In the DSDS electronic device, if one of the two SIMs transmits and/or receives a signal, the other SIM may exist in a standby state.

An electronic device capable of simultaneously operating two SIMs in an active state via a plurality of transceivers may be referred to as a dual SIM dual active (DSDA) electronic device.

If the electronic device includes two SIMs (e.g., a SIM1 and a SIM2), the SIM1 may be a designated data subscription (DDS) SIM and the SIM2 may be a non-designated data subscription (non-DDS) SIM. The DDS SIM may be a SIM designated for using mobile data among a plurality of SIMs included in the electronic device. For example, the DDS SIM may be a SIM designated to use mobile data by default among the plurality of SIMs included in the electronic device. The non-DDS SIM may be a SIM which is not the DDS SIM. The SIM1 may be a SIM used for attaching to a first communication network and the SIM2 may be a SIM used for attaching to a second communication network.

The electronic device may provide a non-3rd generation partnership project (non-3GPP) Internet protocol (IP) access via a radio frequency (RF) path related to the SIM1 and an RF path related to the SIM2. The non-3GPP IP access may include a wireless-fidelity (WiFi) access. Hereinafter, for convenience of a description, the RF path related to the SIM1 will be referred to as a “SIM1 path” and the RF path related to the SIM2 will be referred to as a “SIM2 path.” The electronic device may provide a 3GPP access via the SIM1 path and the SIM2 path. The 3GPP access may include a long-term evolution (LTE) access and/or a new radio (NR) access.

The electronic device may, for example, provide a call service and a rich communication suite (RCS) service via the SIM2 path, for the SIM2 which is the non-DDS SIM. Although the call service and the RCS service may be provided via a WiFi connection, the electronic device may provide the call service and the RCS service over an LTE connection on the SIM2 path. In the electronic device, a service may be provided via an LTE connection on the SIM1 path as well as the SIM2 path.

While the service is being provided via the LTE connection on both the SIM1 path and the SIM2 path, a call related to the SIM1 and a call related to the SIM2 may occur in the LTE network, and in this case, a paging conflict may occur. Since the service is provided via the LTE connection on both the SIM1 path and the SIM2 path, a resource conflict may occur due to transmission and reception of control signals and transmission and reception of user data, and performance degradation may occur due to the resource conflict. In addition, even though the service may be provided via the WiFi connection on both the SIM1 path and the SIM2 path, if the service is provided via the LTE connection, power consumption of the electronic device may increase, and performance degradation may occur due to the increased power consumption.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for controlling a packet data network (PDN) connection and an operating method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a radio frequency (RF) circuit, memory, comprising one or more storage media, storing instructions, and at least one processor operatively connected to the RF circuit and the memory, wherein the instructions, when executed by the at least one processor individually or collectively, cause the electronic device to establish a first Internet packet data network (PDN) connection related to a first subscriber identity module (SIM) by performing an attach procedure with a first communication network via at least one first RF path related to the first SIM among a plurality of RF paths supportable in the electronic device, and, based on the first Internet PDN connection, perform a registration procedure with a second Internet protocol (IP) multimedia subsystem (IMS) connected to a second communication network, wherein the first SIM is used for attaching to the first communication network, and a second SIM is used for attaching to the second communication network.

In accordance with another aspect of the disclosure, a method of operating an electronic device is provided. The method includes establishing a first Internet packet data network (PDN) connection related to a first subscriber identity module (SIM) used for attaching to a first communication network by performing an attach procedure with the first communication network via at least one first radio frequency (RF) path related to the first SIM among a plurality of RF paths supportable in the electronic device, and, based on the first Internet PDN connection, performing a registration procedure with a second Internet protocol (IP) multimedia subsystem (IMS) connected to a second communication network related to a second SIM, wherein the first SIM is used for attaching to the first communication network, and the second SIM is used for attaching to the second communication network.

In accordance with another aspect of the disclosure, one or more non-transitory computer readable storage media storing one or more computer programs including computer-executable instructions that, when executed by at least one processor of an electronic device individually or collectively, cause the electronic device to perform operations are provided. The operations include establishing a first Internet packet data network (PDN) connection related to a first subscriber identity module (SIM) by performing an attach procedure with a first communication network via at least one first radio frequency (RF) path related to the first SIM among a plurality of RF paths supportable in the electronic device, and, based on the first Internet PDN connection, performing a registration procedure with a second Internet protocol (IP) multimedia subsystem (IMS) connected to a second communication network related to a second SIM, wherein the first SIM is used for attaching to the first communication network, and the second SIM is used for attaching to the second communication network.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a block diagram schematically illustrating an electronic device in a network environment according to an embodiment of the disclosure;

FIG. 1B is a diagram illustrating a network environment including an electronic device according to an embodiment of the disclosure;

FIG. 1C is a block diagram schematically illustrating an example of an internal structure of an electronic device according to an embodiment of the disclosure;

FIG. 2A is a block diagram illustrating an electronic device for supporting a legacy network communication and a 5th generation (5G) network communication according to an embodiment of the disclosure;

FIG. 2B is a block diagram illustrating an electronic device for supporting a legacy network communication and a 5G network communication according to an embodiment of the disclosure;

FIG. 3A is a diagram illustrating a wireless communication system which provides a legacy communication network and/or a 5G communication network according to an embodiment of the disclosure;

FIG. 3B is a diagram illustrating a wireless communication system which provides a legacy communication network and/or a 5G communication network according to an embodiment of the disclosure;

FIG. 3C is a diagram illustrating a wireless communication system which provides a legacy communication network and/or a 5G communication network according to an embodiment of the disclosure;

FIG. 4 is a diagram illustrating a structure of a wireless communication system according to an embodiment of the disclosure;

FIG. 5 is a block diagram illustrating an electronic device according to an embodiment of the disclosure;

FIG. 6 is a block diagram illustrating an electronic device according to an embodiment of the disclosure;

FIG. 7 is a flowchart illustrating an operating method of an electronic device according to an embodiment of the disclosure;

FIG. 8 is a signal flow diagram illustrating a PDN connection control operation in a wireless communication system according to an embodiment of the disclosure;

FIG. 9 is a diagram schematically illustrating a format of a message including information related to an Internet PDN connection established between an electronic device and a first communication network according to an embodiment of the disclosure;

FIG. 10 is a flowchart illustrating an operating process of an electronic device according to an embodiment of the disclosure;

FIG. 11 is a signal flow diagram illustrating a PDN connection control operation in a wireless communication system according to an embodiment of the disclosure;

FIG. 12 is a signal flow diagram illustrating a PDN connection control operation in a wireless communication system according to an embodiment of the disclosure;

FIG. 13 is a diagram for explaining an operation according to a priority between SIMs according to an embodiment of the disclosure; and

FIG. 14 is a diagram for explaining a PDN connection control operation in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be noted that the technical terms used herein are only used to describe a specific embodiment, and are not intended to limit an embodiment of the disclosure. Alternatively, the technical terms used herein should be interpreted to have the same meaning as those commonly understood by a person skilled in the art to which the disclosure pertains, and should not be interpreted have excessively comprehensive or excessively restricted meanings unless particularly defined as other meanings. Alternatively, when the technical terms used herein are wrong technical terms that cannot correctly represent the idea of the disclosure, it should be appreciated that they are replaced by technical terms correctly understood by those skilled in the art. Alternatively, the general terms used in an embodiment of the disclosure should be interpreted as defined in dictionaries or interpreted in the context of the relevant part, and should not be interpreted to have excessively restricted meanings.

Alternatively, a singular expression used herein may include a plural expression unless they are definitely different in the context. As used herein, such an expression as “comprises” or “include”, or the like should not be interpreted to necessarily include all elements or all operations described in the specification, and should be interpreted to be allowed to exclude some of them or further include additional elements or operations.

The terms including an ordinal number, such as expressions “a first” and “a second” may be used to describe various elements, but the corresponding elements should not be limited by such terms. These terms are used merely to distinguish between one element and any other element. For example, a first element may be termed a second element, and similarly, a second element may be termed a first element without departing from the scope of the disclosure.

It should be understood that when an element is referred to as being “connected” or “coupled” to another element, it may be connected or coupled directly to the other element, or any other element may be interposer between them. In contrast, it should be understood that when an element is referred to as being “directly connected” or “directly coupled” to another element, there are no element interposed between them.

An embodiment of the disclosure will be described in detail with reference to the accompanying drawings. Regardless of drawing signs, the same or like elements are provided with the same reference numeral, and a repeated description thereof will be omitted. Alternatively, in describing an embodiment of the disclosure, a detailed description of relevant known technologies will be omitted when it is determined that the description may make the subject matter of the disclosure unclear. Alternatively, it should be noted that the accompanying drawings are presented merely to help easy understanding of the technical idea of the disclosure, and should not be construed to limit the technical idea of the disclosure. The technical idea of the disclosure should be construed to cover all changes, equivalents, and alternatives, in addition to the drawings.

Hereinafter, an electronic device will be described in an embodiment of the disclosure, but the electronic device may be referred to as a terminal, a mobile station, a mobile equipment (ME), a user equipment (UE), a user terminal (UT), a subscriber station (SS), a wireless device, a handheld device, and an access terminal (AT). Alternatively, in an embodiment of the disclosure, the electronic device may be a device having a communication function such as, for example, a mobile phone, a personal digital assistant (PDA), a smart phone, a wireless modulator-demodulator (MODEM), and a notebook.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

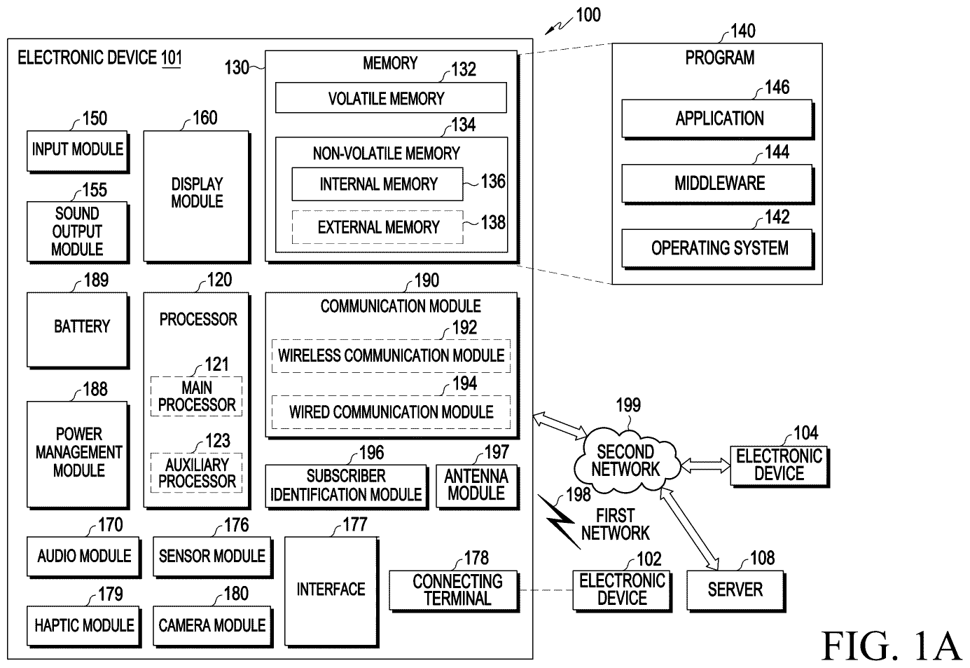

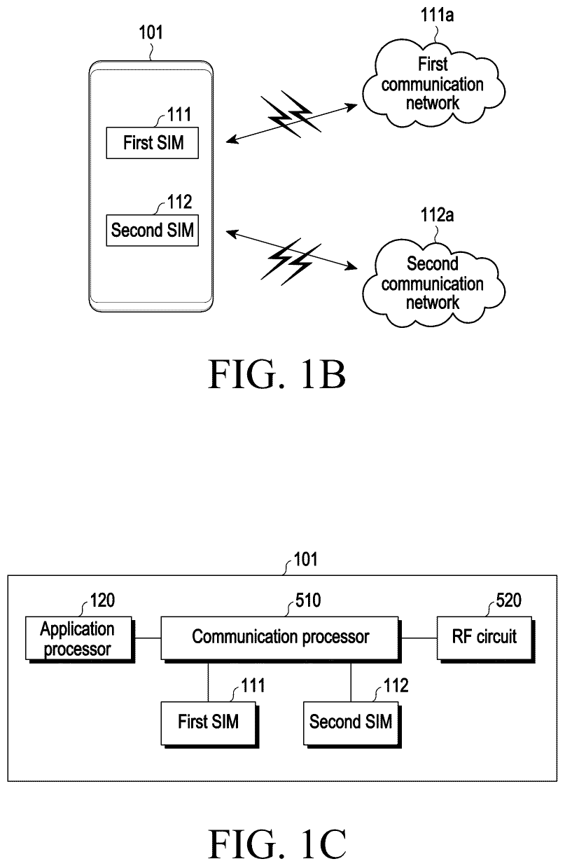

FIG. 1A is a block diagram illustrating an electronic device 101 in a network environment 100 according to an embodiment of the disclosure.

Referring to FIG. 1A, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to another embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. In one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. In an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to another embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be, for example, generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be, for example, used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to another embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. In an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. In an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to another embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to another embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. In an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (WiFi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). The wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to another embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. In an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to yet another embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to another embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may, for example, provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment, the electronic devices are not limited to those described above.

It should be appreciated that various embodiments of the disclosure and the terms used therein are not intended to limit the technological features set forth herein to an embodiment and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). In an example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to other embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

FIG. 1B is a diagram illustrating a network environment including an electronic device according to an embodiment of the disclosure.

Referring to FIG. 1B, a network according to an embodiment may include an electronic device 101 (e.g., an electronic device 101 in FIG. 1A), a first communication network 111a, and/or a second communication network 112a.

An electronic device 101 may be a multi-SIM electronic device supporting a plurality of SIMs. If the electronic device 101 supports two SIMs, the electronic device 101 may be a dual SIM dual standby (DSDS) electronic device or a dual SIM dual active (DSDA) electronic device. The electronic device 101 may include two SIMs (e.g., a first SIM 111 and a second SIM 112). There is no limitation on a type of each of the first SIM 111 and the second SIM 112. For example, each of the first SIM 111 and the second SIM 112 may be a removable SIM (rSIM) (e.g., a SIM card). The electronic device 101 may include a first slot (not shown) and a second slot (not shown) to accommodate the first SIM 111 and the second SIM 112, respectively. In this case, those skilled in the art will understand that the fact that the electronic device 101 includes the first SIM 111 and the second SIM 112 may mean that the first SIM 111 and the second SIM 112 are mounted in the electronic device 101, and may not mean that the first SIM 111 and the second SIM 112 are necessarily included in the electronic device 101. For another example, at least one of the first SIM 111 and the second SIM 112 may include an embedded subscriber identity module (eSIM). An eSIM may also be referred to as an embedded universal integrated circuit card (UICC) (eUICC).

In an embodiment, the first SIM 111 is a SIM subscribed to a communication carrier of the first communication network 111a, and the electronic device 101 may use the first SIM 111 to attach to the first communication network 111a, and receive a wireless communication service from the first communication network 111a. According to an embodiment, the first communication network 111a may include an evolved packet system (EPS) (or, a 5th generation system (5GS)), and/or an evolved packet core (EPC) (or, a 5th generation core network (5GC)) of a first communication carrier. The first communication network 111a may be connected to a first an Internet protocol (IP) multimedia subsystem (IMS) (not shown in FIG. 1B) which is an IMS of the first communication carrier. According to an embodiment, the first SIM 111 may be a designated data subscription (DDS) SIM. It may be a SIM designated for using mobile data among a plurality of SIMs included in the electronic device. For example, the DDS SIM may be a SIM designated to use the mobile data by default among the plurality of SIMs included in the electronic device.

The second SIM 112 is a SIM subscribed to a communication carrier of the second communication network 112a, and the electronic device 101 may use the second SIM 112 to attach to the second communication network 112a, and receive a wireless communication service from the second communication network 112a. In an embodiment, the second communication network 112a may include an EPS (or a 5GS) and/or an EPC (or a 5GC) of a second communication carrier. According to an embodiment, the second communication network 112a may be connected to a second IMS (not shown in FIG. 1B) which is an IMS of the second communication carrier. According to an embodiment, the second SIM 112 may be a non-designated data subscription (non-DDS) SIM. The non-DDS SIM may be a SIM which is not the DDS SIM.

According to another embodiment, although not separately shown in FIG. 1B, the first SIM 111 and the second SIM 112 may be SIMs subscribed to a communication carrier of the same communication network. For example, each of the first SIM 111 and the second SIM 112 may be a SIM corresponding to different subscriber information subscribed to the same communication carrier.

FIG. 1C is a block diagram schematically illustrating an example of an internal structure of an electronic device according to an embodiment of the disclosure.

Referring to FIG. 1C, an electronic device 101 (e.g., an electronic device 101 in FIG. 1A or 1B) may include at least one of an application processor 120 (e.g., a processor 120 in FIG. 1A), a communication processor 510, a radio frequency (RF) circuit 520, a first SIM 111, or a second SIM 112. At least one of the first SIM 111 or the second SIM 112 may be a removable SIM (rSIM). In this case, the electronic device 101 may further include at least one slot for connection with the rSIM. In an embodiment, the rSIM is removable from the electronic device 101 and does not necessarily need to be included in the electronic device 101. At least one of the first SIM 111 or the second SIM 112 may be an embedded subscriber identity module (eSIM). The rSIM may be referred to as a “physical SIM (pSIM).”

According to an embodiment, the communication processor 510 may support a specified number (e.g., two) of SIMs. Although not illustrated in FIG. 1C, the electronic device 101 may include SIMs (e.g., two rSIMs and one eSIM) whose number is greater than a specified number. In this case, the electronic device 101 may further include a switch (not illustrated in FIG. 1C) for converting a SIM connection between a plurality of SIMs and the communication processor 510.

The communication processor 510 may support establishment of a communication channel of a band to be used for a wireless communication and a network communication through the established communication channel. For example, the communication processor 510 may support at least one of a 2^{nd} generation (2G) network communication, a 3^{rd} generation (3G) network communication, a 4^{th} generation (4G) network communication, or a 5^{th} generation (5G) network communication.

The RF circuit 520 may include at least one of a radio frequency integrated circuit (RFIC), a radio frequency front end (RFFE) module, or an antenna module (e.g., an antenna module 197 in FIG. 1A). The RF circuit 520 may convert data (e.g., a baseband signal) outputted from the communication processor 510 into an RF signal and transmit the RF signal via the antenna module. The RF circuit 520 may convert an RF signal received via the antenna module into a baseband signal and transfer the baseband signal to the communication processor 510. According to another embodiment, the RF circuit 520 may use a plurality of RF paths, and at least one first RF path among the plurality of RF paths may be an RF path related to the first SIM 111. At least one second RF path among the plurality of RF paths may be an RF path related to the second SIM 112. The RF circuit 520 may process an RF signal or a baseband signal based on a communication scheme supported by the communication processor 510, and a type of the RF circuit 520 is not limited. According to yet another embodiment, an interface between components may be implemented as a general purpose input/output (GPIO), universal asynchronous receiver/transmitter (UART) (e.g., high speed-UART (HS-UART)), or peripheral component interconnect bus express (PCIe) interface, and there is no limitation on the interface between the components. Alternatively, at least some of the components may exchange control information or packet data information using a shared memory.

Although FIG. 1C illustrates a case in which the processor 120 and the communication processor 510 are implemented as separate hardware, this is merely illustrative. The processor 120 and the communication processor 510 may be, for example, implemented as separate hardware, and the processor 120 and the communication processor 510 may also be implemented on a single chip.

The communication processor 510 may obtain stored information from the first SIM 111 and the second SIM 112. For example, the stored information may include at least one of an integrated circuit card identifier (ICCID), an IMSI, home public land mobile network (HPLMN) related information, or a mobile subscriber international integrated service digital network (ISDN) number (MSISDN). The stored information may also be referred to as an elementary file (EF). The communication processor 510 may perform, via the RF circuit 520, an authentication procedure for a network communication which corresponds to the first SIM 111 and/or the second SIM 112 based on the obtained information stored in the first SIM 111 and/or the second SIM 112. If authentication is successful, the communication processor 510 may perform, via the RF circuit 520, a network communication which corresponds to the first SIM 111 and/or the second SIM 112.

The communication processor 510 may perform network communications of dual SIM according to the first SIM 111 or the second SIM 112. Depending on implementation of the RF circuit 520, the network communications of the dual SIM may be performed in one of a DSDS mode or a DSDA mode. According to an embodiment, the first SIM 111 may be a DDS SIM and the second SIM 112 may be a non-DDS SIM.

According to another embodiment, the communication processor 510 may include two stacks (e.g., a stack according to ISO7816) for processing a SIM, and the first SIM 111 and the second SIM 112 may be connected to the two stacks. For example, a first slot may be connected to one stack, and a second slot may be connected to another stack.

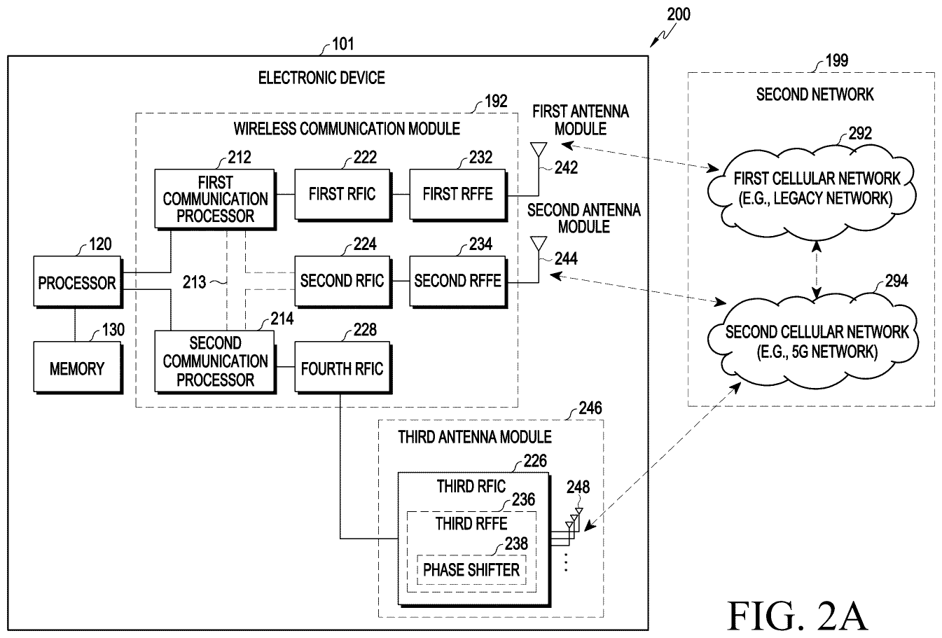

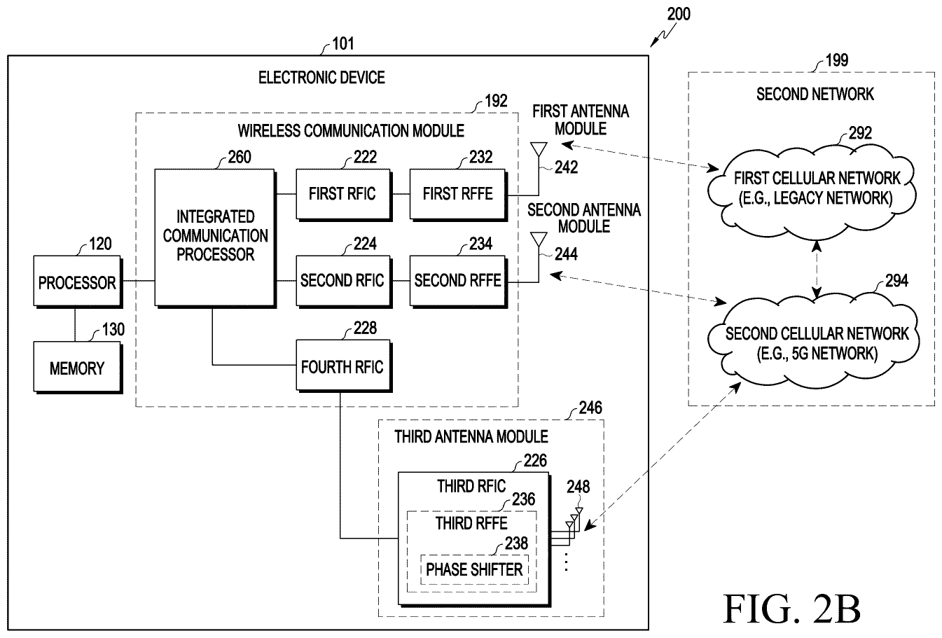

FIG. 2A is a block diagram 200 illustrating an electronic device for supporting a legacy network communication and a 5^{th} generation (5G) network communication according to an embodiment of the disclosure.

Referring to FIG. 2A, an electronic device 101 (e.g., an electronic device 101 in FIG. 1A, 1B, or 1C) may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 244, and/or antennas 248. The electronic device 101 may further include a processor 120 and memory 130. A second network 199 may include a first cellular network 292 and a second cellular network 294.

In an embodiment, the electronic device 101 may further include at least one of the components illustrated in FIG. 1A, and the second network 199 may further include at least one other network. The first communication processor 212, the second communication processor 214, the first RFIC 222, the second RFIC 224, the fourth RFIC 228, the first RFFE 232, and/or the second RFFE 234 may form at least part of a wireless communication module 192. In an embodiment, the fourth RFIC 228 may be omitted or included as part of the third RFIC 226.

The first communication processor 212 may establish a communication channel in a band to be used for a wireless communication with the first cellular network 292 and support a legacy network communication via the established communication channel. In an embodiment, the first cellular network 292 may be a legacy network including a 2^{nd} generation (2G) network, a 3^{rd} generation (3G) network, and/or a 4^{th} generation (4G) (e.g., a long term evolution (LTE)) network. The second communication processor 214 may establish a communication channel corresponding to a specified band (e.g., about 6 GHz to about 60 GHz) out of a band to be used for a wireless communication with the second cellular network 294 and support a 5G network communication via the established communication channel. In an embodiment, the second cellular network 294 may be a 5G network (e.g., a new radio (NR) network) defined by 3GPP. According to an embodiment, the first communication processor 212 or the second communication processor 214 may establish a communication channel corresponding to another specified band (e.g., about 6 GHz or less) out of the band to be used for the wireless communication with the second cellular network 294 and support a 5G network communication via the established communication channel.

The first communication processor 212 may transmit and receive data to and from the second communication processor 214. In an example, data supposed to be transmitted via the second cellular network 294 may be scheduled to be transmitted via the first cellular network 292. In this case, the first communication processor 212 may receive transmission data from the second communication processor 214. For example, the first communication processor 212 may exchange data with the second communication processor 214 via an inter-processor interface 213. For example, the inter-processor interface 213 may be implemented as a universal asynchronous receiver/transmitter (UART) (e.g., high speed-UART (HS-UART)) interface or a peripheral component interconnect bus express (PCIe) interface, but a type thereof is not limited. In another example, the first communication processor 212 and the second communication processor 214 may exchange control information and packet data information using a shared memory. The first communication processor 212 may transmit and receive various pieces of information such as sensing information, information about output strength, and/or resource block (RB) allocation information to and from the second communication processor 214.

Depending on implementation, the first communication processor 212 may not be coupled directly to the second communication processor 214. In this case, the first communication processor 212 may exchange data with the second communication processor 214 via the processor 120 (e.g., an application processor). In an example, the first communication processor 212 and the second communication processor 214 may transmit and receive data to and from the processor 120 via an HS-UART interface or a PCIe interface, but a type of an interface is not limited. In an embodiment, the first communication processor 212 and the second communication processor 214 may exchange control information and packet data information by using, for example, the processor 120 and the shared memory.

The first communication processor 212 and the second communication processor 214 may be incorporated in a single chip or a single package. In an embodiment, the first communication processor 212 or the second communication processor 214 may be incorporated together with the processor 120 (e.g., a main processor 121 and an auxiliary processor 123 in FIG. 1A, an auxiliary processor 123, or a processor 120 in FIG. 1C)), or a wireless communication module 192 (e.g., a communication module 190 in FIG. 1A) in a single chip or a single package.

For transmission, the first RFIC 222 may convert a baseband signal generated by the first communication processor 212 to a radio frequency (RF) signal in about 700 MHz to about 3 GHz used in the first cellular network 292 (e.g., the legacy network). For reception, an RF signal may be obtained from the first cellular network 292 (e.g., a legacy network) via an antenna (e.g., the first antenna module 242) and pre-processed via an RFFE (e.g., the first RFFE 232). The first RFIC 222 may, for example, convert the pre-processed RF signal to a baseband signal so that the baseband signal may be processed by the first communication processor 212.

For transmission, the second RFIC 224 may convert a baseband signal generated by the first communication processor 212 or the second communication processor 214 to an RF signal in a Sub6 band (e.g., about 6 GHz or less) used in the second cellular network 294 (e.g., the 5G network). For reception, a 5G Sub6 RF signal may be obtained from the second cellular network 294 (e.g., the 5G network) via an antenna (e.g., the second antenna module 244) and pre-processed in an RFFE (e.g., the second RFFE 234). The second RFIC 224 may convert the pre-processed 5G Sub6 RF signal to a baseband signal so that the baseband signal may be processed by a corresponding one between the first communication processor 212 and the second communication processor 214.

For transmission, the third RFIC 226 may convert a baseband signal generated by the second communication processor 214 to an RF signal (hereinafter, referred to as, a 5G Above6 RF signal) in a 5G Above6 band (e.g., about 6 GHz to about 60 GHz) to be used in the second cellular network 294 (e.g., the 5G network). For reception, a 5G Above6 RF signal may be obtained from the second cellular network 294 (e.g., the 5G network) via an antenna (e.g., the antenna 248) and pre-processed via the third RFFE 236. The third RFIC 226 may convert the pre-processed 5G Above6 RF signal to a baseband signal so that the baseband signal may be processed by the second communication processor 214. According to an embodiment, the third RFFE 236 may be formed as part of the third RFIC 226.

In an embodiment, the electronic device 101 may include the fourth RFIC 228 separately from or as part of the third RFIC 226. In this case, the fourth RFIC 228 may convert a baseband signal generated by the second communication processor 214 to an RF signal in an intermediate frequency (IF) band (e.g., about 9 GHz to about 11 GHz) (hereinafter, referred to as an IF signal), and provide the IF signal to the third RFIC 226. The third RFIC 226 may, for example, convert the IF signal to a 5G Above6 RF. During reception, a 5G Above6F signal may be received from the second cellular network 294 (e.g., the 5G network) via an antenna (e.g., the antenna 248) and converted to an IF signal by the third RFIC 226. The fourth RFIC 228 may convert the IF signal to a baseband signal so that the baseband signal may be processed by the second communication processor 214.

According to another embodiment, the first RFIC 222 and the second RFIC 224 may be implemented as at least part of a single chip or a single package. In an embodiment, if the first RFIC 222 and the second RFIC 224 are implemented as a single chip or a single package in FIG. 2A, the first RFIC 222 and the second RFIC 224 may be implemented as an integrated RFIC. In this case, the integrated RFIC is connected to the first RFFE 232 and the second RFFE 234, so the integrated RFIC may convert a baseband signal into a signal of a band supported by the first RFFE 232 and/or the second RFFE 234, and transfer the converted signal to one of the first RFFE 232 and the second RFFE 234. The first RFFE 232 and the second RFFE 234 may be implemented as at least part of a single chip or a single package. According to an embodiment, at least one of the first antenna module 242 or the second antenna module 244 may be omitted or combined with the other antenna module to process RF signals in a plurality of corresponding bands.

According to yet another embodiment, the third RFIC 226 and the antenna 248 may be arranged on the same substrate to form a third antenna module 246. For example, the wireless communication module 192 or the processor 120 may be arranged on a first substrate (e.g., a main PCB). In this case, the third RFIC 226 may be arranged in a partial area (e.g., the bottom surface) of a second substrate (e.g., a sub PCB) other than the first substrate and the antenna 248 may be arranged in another partial area (e.g., the top surface) of the second substrate, to form the third antenna module 246. As the third RFIC 226 and the antenna 248 are arranged on the same substrate, it is possible to reduce length of a transmission line between the third RFIC 226 and the antenna 248. By reducing the length of the transmission line between the third RFIC 226 and the antenna 248, amount of loss (e.g., attenuation) of a high frequency band (e.g., about 6 GHz to about 60 GHz) signal used for a 5G network communication due to the transmission line may be reduced. Therefore, the electronic device 101 may increase quality or a speed of a communication with the second cellular network 294 (e.g., the 5G network).

The antenna 248 may be formed as an antenna array including a plurality of antenna elements which may be used for beamforming. In this case, the third RFIC 226 may include a plurality of phase shifters 238 corresponding to the plurality of antenna elements, as part of the third RFFE 236. During transmission, each of the plurality of phase shifters 238 may change a phase of a 5G Above6 RF signal to be transmitted to the outside of the electronic device 101 (e.g., a base station (e.g., a gNB) in the 5G network) via a corresponding antenna element. During reception, each of the phase shifters 238 may change a phase of a 5G Above6 RF signal received from the outside via a corresponding antenna element to the same or substantially same phase. This enables transmission or reception via beamforming between the electronic device 101 and the outside of the electronic device 101.

The second cellular network 294 (e.g., the 5G network) may be operated independently of (e.g., a stand-alone (SA) structure) or interworked with (e.g., a non-stand alone (NSA) structure) the first cellular network 292 (e.g., the legacy network). For example, in the 5G network, only an access network (e.g., a 5G radio access network (RAN) or next generation RAN (NG RAN)) may exist, and a core network (e.g., a next generation core (NGC)) may not exist. In this case, after accessing the access network of the 5G network, the electronic device 101 may access an external network (e.g., an Internet) under the control of a core network (e.g., an evolved packet core (EPC)) of the legacy network. Protocol information for a communication with the legacy network (e.g., LTE protocol information) and protocol information for a communication with the 5G network (e.g., NR protocol information) may be, for example, stored in the memory 230 and accessed by other components (e.g., the processor 120, the first communication processor 212, or the second communication processor 214).

FIG. 2B is a block diagram 250 illustrating an electronic device for supporting a legacy network communication and a 5G network communication according to an embodiment of the disclosure.

Referring to FIG. 2B, an electronic device 101 (e.g., an electronic device 101 in FIG. 1A, 1B, or 1C) may include an integrated communication processor 260 (e.g., a communication processor 510 in FIG. 1C), a first RFIC 222, a second RFIC 224, a third RFIC 226, a fourth RFIC 228, a first RFFE 232, a second RFFE 234, a first antenna module 242, a second antenna module 244, a third antenna module 246, and/or antennas 248. The electronic device 101 may further include a processor 120 and memory 130. A second network 199 may include a first cellular network 292 and a second cellular network 294.

In the block diagram 250 of the electronic device 101 shown in FIG. 2B comparing to the block diagram 200 of the electronic device 101 shown in FIG. 2A, it differs only in that the first communication processor 212 and the second communication processor 214 are implemented as the integrated communication processor 260, and the remaining components included in the block diagram 250 of the electronic device 101 may be implemented similarly or substantially the same as the components included in the block diagram 200 of the electronic device 101 shown in FIG. 2A, so a detailed description thereof will be omitted.

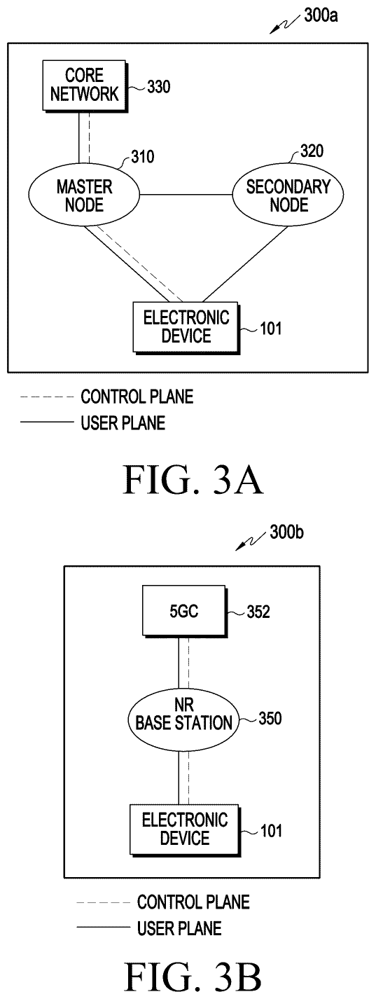

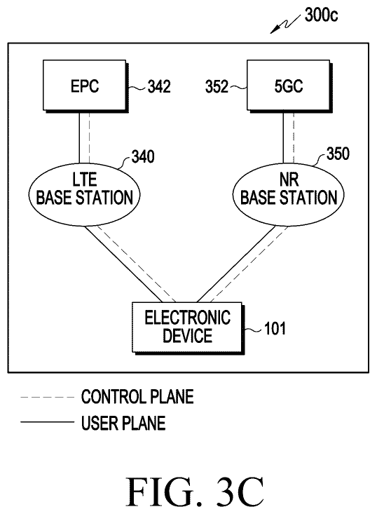

FIG. 3A is a diagram illustrating a wireless communication system which provides a legacy communication network and/or a 5G communication network according to an embodiment of the disclosure.

Referring to FIG. 3A, a network environment 300a may include at least one of a legacy network or a 5G network. In an embodiment, the legacy network may include a 4G or LTE base station (e.g., an eNodeB (eNB)) of the 3GPP standard supporting a wireless attachment of an electronic device 101 (e.g., an electronic device 101 in FIG. 1A, 1B, 1C, 2A, or 2B), and an EPC which manages a 4G communication. The 5G network may include an NR base station (e.g., a gNodeB (gNB)) supporting a wireless attachment of the electronic device 101, and a 5GC which manages a 5G communication of the electronic device 101.

According to an embodiment, the electronic device 101 may transmit and receive a control message and user data via a legacy communication and/or a 5G communication. The control message may include a message related to at least one of security control, bearer setup, authentication, registration, or mobility management of the electronic device 101. The user data may mean user data except for a control message transmitted and received between the electronic device 101 and a core network 330 (e.g., the EPC 342).

The electronic device 101 may transmit and receive at least one of a control message or user data to and from at least part (e.g., an NR base station and a 5GC) of the 5G network using at least part (e.g., an LTE base station and an EPC) of the legacy network.

The network environment 300a may include a network environment which provides dual connectivity (DC) to the LTE base station and the NR base station and transmits and receives a control message to and from the electronic device 101 via one core network 330 of the EPC or the 5GC.

According to another embodiment, in a DC environment, one of the LTE base station and the NR base station may operate as a master node (MN) 310 and the other may operate as a secondary node (SN) 320. The MN 310 may be connected to the core network 330 and transmit and receive a control message to and from the core network 330. The MN 310 and the SN 320 may be connected to each other via a network interface and transmit and receive a message related to management of a wireless resource (e.g., a communication channel) to and from each other.

According to still another embodiment, the MN 310 may include the LTE base station, the SN 320 may include the NR base station, and the core network 330 may include the EPC. For example, a control message may be transmitted and received via the LTE base station and the EPC, and user data may be transmitted via at least one of the LTE base station or the NR base station.

In an embodiment, the MN 310 may include the NR base station, the SN 320 may include the LTE base station, and the core network 330 may include the 5GC. For example, a control message may be transmitted and received via the NR base station and the 5GC, and user data may be transmitted via at least one of the LTE base station or the NR base station.

FIG. 3B is a diagram illustrating a wireless communication system which provides a legacy communication network and/or a 5G communication network according to an embodiment of the disclosure.

Referring to FIG. 3B, a network environment 300b may include at least one of a legacy network or a 5G network. In an embodiment, the legacy network may include a 4G or LTE base station (e.g., an eNodeB (eNB)) of the 3GPP standard supporting a wireless attachment of an electronic device 101 (e.g., an electronic device 101 in FIG. 1A, 1B, 1C, 2A, or 2B), and an EPC which manages a 4G communication. The 5G network may include an NR base station 350 (e.g., a gNodeB (gNB)) supporting a wireless attachment of the electronic device 101, and a 5GC 352 which manages a 5G communication of the electronic device 101.

According to an embodiment, the electronic device 101 may transmit and receive a control message and user data through a legacy communication and/or a 5G communication.

The 5G network may include an NR base station 350 and a 5GC 352, and may transmit and receive a control message and user data independently from the electronic device 101.

FIG. 3C is a diagram illustrating a wireless communication system which provides a legacy communication network and/or a 5G communication network according to an embodiment of the disclosure.

Referring to FIG. 3C, a network environment 300c may include at least one of a legacy network or a 5G network. In an embodiment, the legacy network may include a 4G or LTE base station 340 (e.g., an eNodeB (eNB)) of the 3GPP standard supporting a wireless attachment of an electronic device 101 (e.g., an electronic device 101 in FIG. 1A, 1B, 1C, 2A, or 2B), and an EPC 342 which manages a 4G communication. The 5G network may include an NR base station 350 (e.g., a gNodeB (gNB)) supporting a wireless attachment of the electronic device 101, and a 5GC 352 which manages a 5G communication of the electronic device 101.

The electronic device 101 may transmit and receive a control message and user data through a legacy communication and/or a 5G communication.

Each of a legacy network and a 5G network according to an embodiment may independently provide data transmission and reception. For example, an electronic device 101 may transmit and receive a control message and user data to and from the EPC 342 via the LTE base station 340. For another example, the electronic device 101 may transmit and receive a control message and user data to and from the 5GC 352 via the NR base station 350.

In an embodiment, the electronic device 101 may be registered in at least one of the EPC 342 or the 5GC 352, and transmit and receive a control message.

According to another embodiment, the EPC 342 and the 5GC 352 may interwork and manage a communication of the electronic device 101. For example, mobility information of the electronic device 101 may be transmitted and received via an interface between the EPC 342 and the 5GC 352.

As described above, DC through the LTE base station 340 and the NR base station 350 may be referred to as E-UTRA new radio dual connectivity (EN-DC).

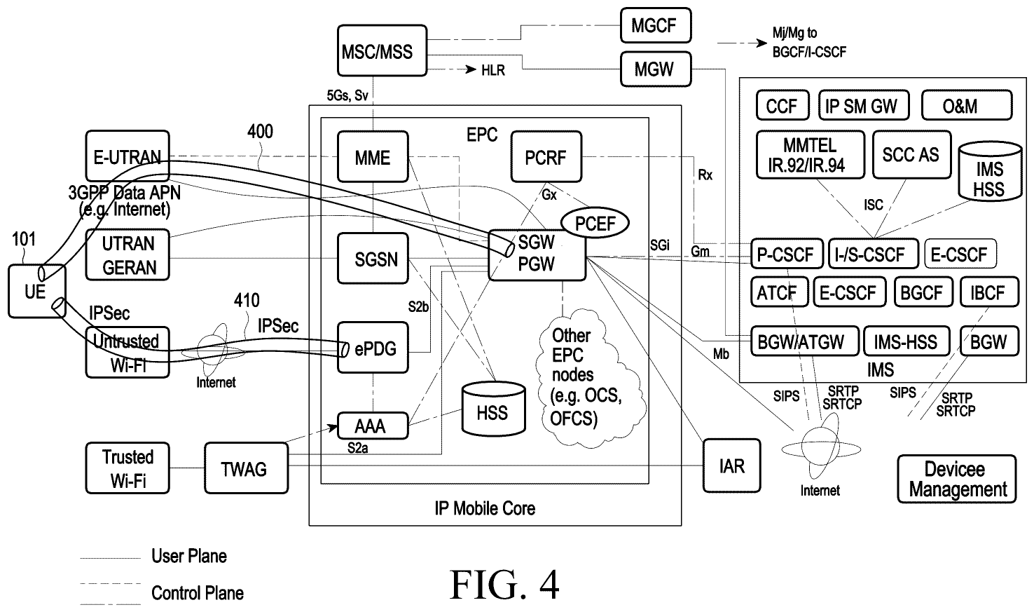

FIG. 4 is a diagram illustrating a structure of a wireless communication system according to an embodiment of the disclosure.

Referring to FIG. 4, the wireless communication system may include an EPS (or a 5GS), an EPC (or a 5GC), and/or an IMS. An electronic device 101 (e.g., an electronic device 101 in FIG. 1A, 1B, 1C, 2A, 2B, 3A, 3B, or 3C) (e.g., a user equipment (UE)) may provide a 3rd generation partnership project (3GPP) Internet protocol (IP) access via an evolved universal terrestrial radio access network (E-UTRAN). The 3GPP access may include a long-term evolution (LTE) access and/or a new radio (NR) access. In an embodiment, the 3GPP IP access may be implemented via an LTE connection 400 (e.g., an Internet packet data network (PDN) connection).

The electronic device 101 may provide non-3rd generation partnership project (non-3GPP) IP access. According to an embodiment, the non-3GPP IP access may be implemented via a WiFi connection 410.

If the electronic device 101 includes two SIMs (e.g., a SIM1 and a SIM2), the SIM1 (e.g., a first SIM 111 in FIG. 1B or 1C) may be a DDS SIM, and the SIM2 (e.g., a second SIM 112 in FIG. 1B or 1C) may be a non-DDS SIM. The electronic device 101 may provide a WiFi connection 410 via an RF path related to the SIM1 and an RF path related to the SIM2. Hereinafter, for convenience of a description, the RF path related to the SIM1 will be referred to as a “SIM1 path”, and the RF path related to the SIM2 will be referred to as a “SIM2 path”. The electronic device may provide an LTE connection 400 via the SIM1 path and the SIM2 path.

The electronic device 100 may provide a call service and a rich communication suite (RCS) service via the SIM2 path for the SIM2 which is the non-DDS SIM. Although the call service and the RCS service may be provided via the WiFi connection 410, the electronic device 100 may, for example, provide the call service and the RCS service via the LTE connection 400 on the SIM2 path. In the electronic device 101, a service may be provided via the LTE connection 400 not only on the SIM2 path but also on the SIM1 path. FIG. 4 illustrates a structure of a wireless communication system if a radio access technology (RAT) is LTE, but not only the LTE but also other RATs such as NR may be used.

While the service is being provided via the LTE connection 400 on both the SIM1 path and the SIM2 path, a call related to the SIM1 and a call related to the SIM2 may occur in the LTE network, and in this case, a paging conflict may occur. In this way, since the service is provided via the LTE connection 400 on both the SIM1 path and the SIM2 path, a resource conflict may occur due to transmission and reception of control signals and transmission and reception of user data, and performance degradation may occur due to the resource conflict. In addition, even though the service may be provided via the WiFi connection 410 on the SIM1 path and the SIM2 path, if the service is provided via the LTE connection 400, power consumption of the electronic device may increase, and performance degradation may occur due to the increased power consumption.

An embodiment of the disclosure may provide an electronic device for providing an IMS service related to a SIM2 via an Internet PDN connection related to a SIM1 and an operating method thereof.

By providing the IMS service related to the SIM2 via the Internet PDN connection related to the SIM1, the use of at least one second RF path related to the SIM2 may be turned off, thereby reducing (for example, minimizing) power consumption, preventing performance degradation due to a resource conflict between at least one first RF path related to the SIM1 and the at least one second RF path related to SIM2, and preventing a call conflict between a call related to the SIM1 and a call related to the SIM2.

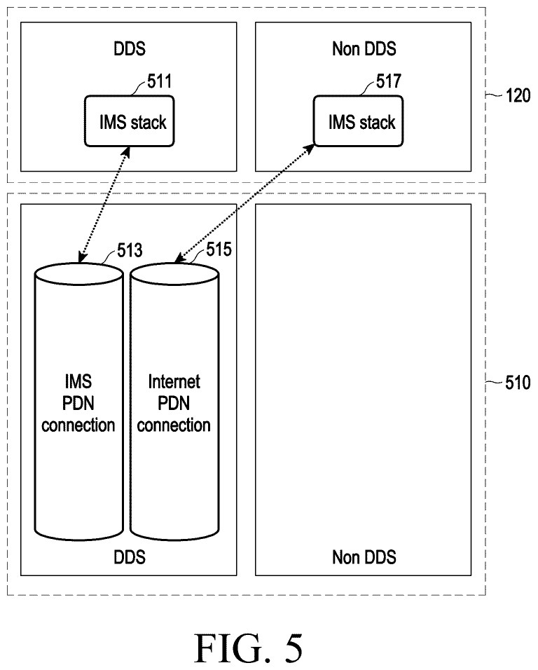

FIG. 5 is a block diagram illustrating an electronic device according to an embodiment of the disclosure.

Referring to FIG. 5, an electronic device (e.g., an electronic device 101 in FIG. 1A, 1B, 1C, 2A, 2B, 3A, 3B, or 3C) may include an application processor (120) (e.g., a processor 120 in FIG. 1A, an application processor 120 in FIG. 1C, or a processor 120 in FIG. 2A or 2B) and/or a communication processor 510 (e.g., a communication processor 510 in FIG. 1C, a first communication processor 212 or a second communication processor 214 in FIG. 2A, or an integrated communication processor 260 in FIG. 2B). The application processor 120 and the communication processor 510 may be implemented as separate hardware. In another implementation example, the application processor 120 and the communication processor 510 may be implemented in a single chip, and there is no limitation on a form of implementation thereof.

If the electronic device is connected to two SIMs (e.g., a SIM1 and a SIM2), the SIM1 (e.g., a first SIM 111 in FIG. 1B or 1C) may be a DDS SIM, and the SIM2 (e.g., a second SIM 112 in FIG. 1B or 1C) may be a non-DDS SIM. For example, the SIMS (e.g., the SIM1 and the SIM2) may be rSIMs and/or eSIMs, and there is no limitation on a type of the SIMs. Those skilled in the art will understand that a case that a SIM is connected to the electronic device 101 may mean, for example, that an rSIM is inserted into a slot of the electronic device 101, and/or that a profile of an eSIM is activated.

The application processor 120 may include (or execute) an IMS stack 511 related to the DDS SIM and/or an IMS stack 517 related to the non-DDS SIM. In FIG. 5, a case that the IMS stack 511 and/or the IMS stack 517 are included (or executed) in the application processor 120 is illustrated as an example in FIG. 5, however, the IMS stack 511 and/or the IMS stack 517 may also be included (or executed) in the communication processor 510.

The IMS stack 511 may perform an operation related to an IMS service related to the DDS SIM. According to an embodiment, the DDS SIM is a SIM subscribed to a communication carrier of a first communication network (e.g., a first communication network 111a in FIG. 1B), and the electronic device 101 may attach to the first communication network using the DDS SIM and receive a wireless communication service from the first communication network. For example, the DDS SIM may support all of an Internet PDN and an IMS PDN. According to an embodiment, the first communication network may include an EPS (or a 5GS) and/or an EPC (or a 5GC) of the first communication carrier. The first communication network may be connected to a first IMS which is an IMS of the first communication carrier, and the IMS stack 511 may perform an operation related to an IMS service provided from the first IMS.

The IMS stack 517 may perform an operation related to an IMS service related to the non-DDS SIM. According to an embodiment, the non-DDS SIM is a SIM subscribed to a communication carrier of a second communication network (e.g., a second communication network 112a in FIG. 1B), and the electronic device 101 may attach to the second communication network using the non-DDS SIM and receive a wireless communication service from the second communication network. According to another embodiment, the second communication network may include an EPS (or a 5GS) and/or an EPC (or a 5GC) of the second communication carrier. The second communication network may be connected to a second IMS which is an IMS of the second communication carrier, and the IMS stack 511 may perform an operation related to an IMS service provided from the second IMS.

In an embodiment, the communication processor 510 may perform an attach procedure with the first communication network via at least one first RF path related to the DDS SIM among a plurality of RF paths which may be supported by the electronic device. The communication processor 510 may establish an Internet PDN connection 515 with the first communication network via the at least one first RF path. The communication processor 510 may establish an IMS PDN connection 513 via the at least one first RF path. The communication processor 510 may perform a registration procedure with the first IMS based on the IMS PDN connection 513.

When the Internet PDN connection 515 related to the DDS SIM is established, the communication processor 510 may perform a registration procedure with the second IMS based on the Internet PDN connection 515 without performing the registration procedure with the second IMS via at least one second RF path related to the non-DDS SIM among a plurality of RF paths supportable in the electronic device. In this way, by providing the IMS service related to the non-DDS SIM via the Internet PDN connection 515 related to the DDS SIM, use of the at least one second RF path related to the non-DDS SIM may be turned off, thereby reducing (for example, minimizing) power consumption, preventing performance degradation due to a resource conflict between the at least one first RF path related to the DDS SIM and the at least one second RF path related to the non-DDS SIM, and preventing a call conflict between a call related to the DDS SIM and a call related to the non-DDS SIM.

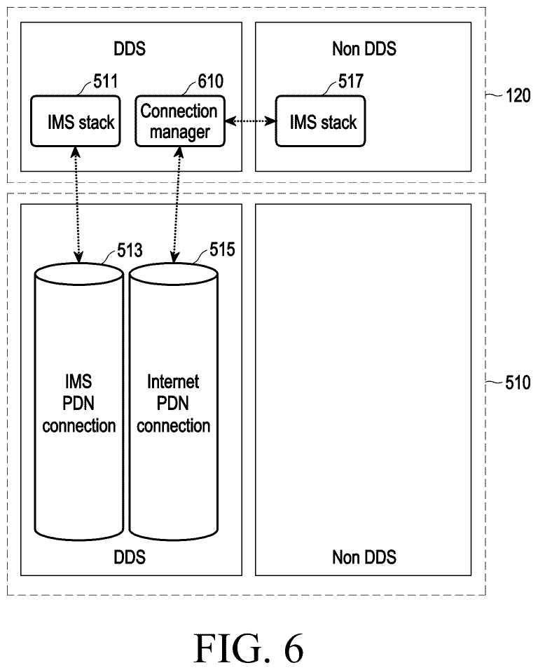

FIG. 6 is a block diagram illustrating an electronic device according to an embodiment of the disclosure.

Referring to FIG. 6, an electronic device (e.g., an electronic device 101 in FIG. 1A, 1B, 1C, 2A, 2B, 3A, 3B, or 3C) may include an application processor (120) (e.g., a processor 120 in FIG. 1A, an application processor 120 in FIG. 1C, or a processor 120 in FIG. 2A or 2B) and/or a communication processor 510 (e.g., a communication processor 510 in FIG. 1C, a first communication processor 212 or a second communication processor 214 in FIG. 2A, or an integrated communication processor 260 in FIG. 2B). The application processor 120 and the communication processor 510 may be implemented as separate hardware. In another implementation example, the application processor 120 and the communication processor 510 may be implemented in a single chip, and there is no limitation on a form of implementation thereof.

If the electronic device includes two SIMs (e.g., a SIM1 and a SIM2), the SIM1 (e.g., a first SIM 111 in FIG. 1B or 1C) may be a DDS SIM, and the SIM2 (e.g., a second SIM 112 in FIG. 1B or 1C) may be a non-DDS SIM.

The application processor 120 may include an IMS stack 511 related to the DDS SIM, an IMS stack 517 related to the non-DDS SIM, and/or a connection manager 610. In FIG. 6, a case that the IMS stack 511, the IMS stack 517, and/or the connection manager 610 are included (or executed) in the application processor 120 is illustrated as an example in FIG. 6, however, the IMS stack 511, the IMS stack 517, and/or the connection manager 610 may also be included (or executed) in the communication processor 510.

The IMS stack 511 and the IMS stack 517 may be implemented to be similar to or substantially the same as those described in FIG. 5, so a detailed description thereof will be omitted herein.

According to another embodiment, the connection manager 610 may manage at least one connection related to the DDS SIM and the non-DDS SIM. According to an embodiment, the at least one connection may include a connection related to an IMS registration procedure of the DDS SIM (e.g., a registration procedure for a first IMS) and/or a connection related to an IMS registration procedure of the non-DDS SIM (e.g., a registration procedure for a second IMS). According to an embodiment, the at least one connection may include an IMS PDN connection and/or an Internet PDN connection related to the DDS SIM, and/or an IMS PDN connection and/or an Internet PDN connection related to the non-DDS SIM. According to an embodiment, the connection manager 610 may be included (or executed) in at least one of the application processor 120 or the communication processor 510.

According to an embodiment, the communication processor 510 may perform an attach procedure with the first communication network via at least one first RF path related to the DDS SIM among a plurality of RF paths which may be supported in the electronic device. The communication processor 510 may, for example, establish an Internet PDN connection 515 with the first communication network via the at least one first RF path. The communication processor 510 may establish an IMS PDN connection 513 via the at least one first RF path. The communication processor 510 may perform a registration procedure with the first IMS based on the IMS PDN connection 513.

The communication processor 510 may transfer, to the connection manager 610, information related to the IMS PDN connection 513 established between the electronic device and the first IMS and/or information related to the Internet PDN connection 515 established between the electronic device and the first communication network.

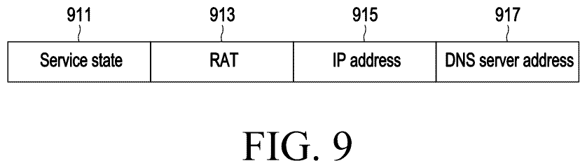

The connection manager 610 may, for example, identify information related to the Internet PDN connection 515 related to the DDS SIM (e.g., first information indicating a RAT related to the DDS SIM, second information indicating a service state of the Internet PDN connection 515 related to the DDS SIM, an IP address obtained when the Internet PDN connection 515 is established, and/or an IP address of a domain name system (DNS) server obtained when the Internet PDN connection 515 is established) based on the information related to the Internet PDN connection 515 received from the communication processor 510. According to an embodiment, the RAT may include various wireless access technologies such as, but not limited to, an LTE technology, an NR technology, and/or Wi-Fi. The service state may indicate that the Internet PDN connection 515 is available. The communication processor 510 may implement the information related to the Internet PDN connection 515 in a form of a message, and a message including the information related to the Internet PDN connection 515 may be implemented in various formats and may not be limited to any one format. The format of the message including the information related to the Internet PDN connection 515 will be described below with reference to FIG. 9, so a detailed description thereof will be omitted herein.

The connection manager 610 which identifies the information related to the Internet PDN connection 515 related to the DDS SIM may transfer the information related to the Internet PDN connection 515 to the IMS stack 517. The connection manager 610 may, for example, implement the information related to the Internet PDN connection 515 in a form of a message, and a message including the information related to the Internet PDN connection 515 may be implemented in various formats and may not be limited to any one format. The format of the message including the information related to the Internet PDN connection 515 will be described below with reference to FIG. 9, so a detailed description thereof will be omitted herein.

The IMS stack 517 which receives the information related to the Internet PDN connection 515 from the connection manager 610 may perform a registration procedure with the second IMS via the Internet PDN connection 515 based on the information related to the Internet PDN connection 515.

When the Internet PDN connection 515 related to the DDS SIM is established, the communication processor 510 may perform a registration procedure with the second IMS based on the Internet PDN connection 515 without performing the registration procedure with the second IMS via at least one second RF path related to the non-DDS SIM among a plurality of RF paths supportable in the electronic device. In this way, by providing the IMS service related to the non-DDS SIM via the Internet PDN connection 515 related to the DDS SIM, use of the at least one second RF path related to the non-DDS SIM may be turned off, thereby reducing (for example, minimizing) power consumption, preventing performance degradation due to a resource conflict between the at least one first RF path related to the DDS SIM and the at least one second RF path related to the non-DDS SIM, and preventing a call conflict between a call related to the DDS SIM and a call related to the non-DDS SIM.

According to an embodiment, an electronic device (e.g., an electronic device 101 in FIG. 1A, 1B, 1C, 2A, 2B, 3A, 3B, or 3C) may include a radio frequency (RF) circuit (e.g., an RF circuit (520) in FIG. 1C), and at least one processor (e.g., a processor 120 in FIG. 1A, an application processor 120 in FIG. 1C, a processor 120 in FIG. 2A or 2B, a communication processor 510 in FIG. 1C, a first communication processor 212 or a second communication processor 214 in FIG. 2A, or an integrated communication processor 260 in FIG. 2B) operatively connected to the RF circuit (e.g., the RF circuit 520 in FIG. 1C).

According to another embodiment of the disclosure, the at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be connected to a first subscriber identity module (SIM) (e.g., a first SIM 111 in FIG. 1B or 1C) used for attaching to a first communication network (e.g., a first communication network 111a in FIG. 1B) and a second SIM (e.g., a second SIM 112 in FIG. 1B or 1C) used for attaching to a second communication network (e.g., a second communication network 112a in FIG. 1B).

The at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be configured to establish a first Internet packet data network (PDN) connection related to the first SIM by performing an attach procedure with the first communication network (e.g., the first communication network 111a in FIG. 1B) via at least one first RF path related to the first SIM among a plurality of RF paths supportable in the electronic device (e.g., an electronic device 101 in FIG. 1A, 1B, 1C, 2A, 2B, 3A, 3B, or 3C).

According to an embodiment of the disclosure, the at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to, based on the first Internet PDN connection, perform a registration procedure with a second Internet protocol (IP) multimedia subsystem (IMS) connected to the second communication network (e.g., the second communication network 112a in FIG. 1B).

The at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be configured to perform the registration procedure for the second IMS based on an IP address related to the first Internet PDN connection, an IP address of a domain name system (DNS) server, or a radio access technology (RAT) used in the first communication network (e.g., the first communication network 111a in FIG. 1B).

According to another embodiment, the at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to release a second IMS PDN connection related to the second SIM (e.g., the second SIM 112 in FIG. 1B or 1C) which is established between the second IMS and the electronic device (e.g., the electronic device 101 in FIG. 1A, 1B, 1C, 2A, 2B, 3A, 3B, or 3C) via at least one second RF path related to the second SIM (e.g., the second SIM 112 in FIG. 1B or 1C) among the plurality of RF paths.

According to an embodiment, the at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to release a second Internet PDN connection related to the second SIM (e.g., the second SIM 112 in FIG. 1B or 1C) which is established between the second communication network (e.g., the second communication network 112a in FIG. 1B) and the electronic device (e.g., the electronic device 101 in FIG. 1A, 1B, 1C, 2A, 2B, 3A, 3B, or 3C) via the at least one second RF path related to the second SIM (e.g., the second SIM 112 in FIG. 1B or 1C) among the plurality of RF paths.

The at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to, via the first IMS PDN connection established between the first IMS connected to the first communication network and the electronic device (e.g., the electronic device 101 in FIG. 1A, 1B, IC, 2A, 2B, 3A, 3B, or 3C), identify that an IMS call related to the second SIM (e.g., the second SIM 112 in FIG. 1B or 1C) from the second IMS exits.

According to another embodiment of the disclosure, the at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to, via the at least one second RF path, establish the second IMS PDN connection related to the second SIM (e.g., the second SIM 112 in FIG. 1B or 1C).

According to an embodiment, the at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to, based on the second IMS PDN connection, perform the registration procedure for the second IMS.

According to yet another embodiment, the at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to, via the second IMS PDN connection, connect the IMS call.

According to another embodiment of the disclosure, the first SIM (e.g., the first SIM 111 in FIG. 1B or 1C) may include a designated data subscription (DDS) SIM designated for using mobile data, and the second SIM (e.g., the second SIM 112 in FIG. 1B or 1C) may include a non-designated data subscription (non-DDS) SIM.

According to an embodiment of the disclosure, the at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to identify that the IMS call is terminated.

In an embodiment of the disclosure, the at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to, via the at least one second RF path, release the second IMS PDN connection.

The at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to, after releasing the second IMS PDN connection, perform the registration procedure for the second IMS based on the first Internet PDN connection.

According to an embodiment of the disclosure, a radio access technology (RAT) used in the first communication network (e.g., the first communication network 111a in FIG. 1B) may include at least one of a long-term evolution (LTE) technology or a new radio (NR) technology.

According to an embodiment, the at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to, before performing the registration procedure for the second IMS based on the first Internet PDN connection, identify whether a WiFi connection is possible.

The at least one processor (e.g., the processor 120 in FIG. 1A, the application processor 120 in FIG. 1C, the processor 120 in FIG. 2A or 2B, the communication processor 510 in FIG. 1C, the first communication processor 212 or the second communication processor 214 in FIG. 2A, or the integrated communication processor 260 in FIG. 2B) may be further configured to, based on the WiFi connection being possible, perform the registration procedure for the second IMS based on the WiFi connection.

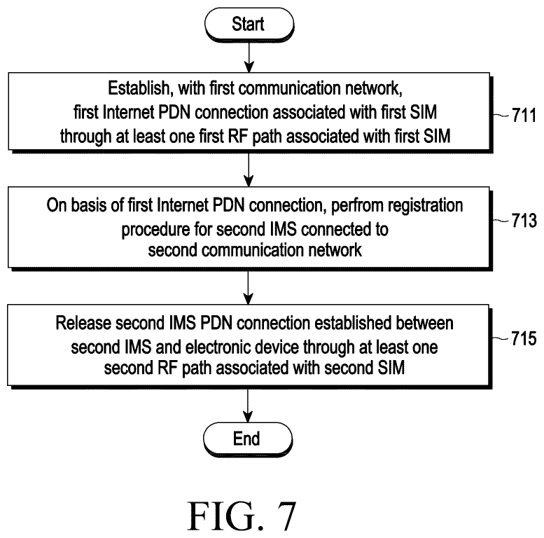

FIG. 7 is a flowchart illustrating an operating method of an electronic device according to an embodiment of the disclosure.

Referring to FIG. 7, an electronic device an electronic device (e.g., an electronic device 101 in FIG. 1A, 1B, 1C, 2A, 2B, 3A, 3B, or 3C) (e.g., a processor 120 in FIG. 1A, an application processor 120 in FIG. 1C, a processor 120 in FIG. 2A or 2B, a communication processor 510 in FIG. 1C, a first communication processor 212 or a second communication processor 214 in FIG. 2A, or an integrated communication processor 260 in FIG. 2B) may perform, in operation 711, an attach procedure with a first communication network (e.g., a first communication network 111a in FIG. 1B) via at least one first RF path related to a first SIM (e.g., a first SIM 111 in FIG. 1B or 1C) to establish a first Internet PDN connection (e.g., an Internet PDN connection 515 in FIG. 5 or 6) related to the first SIM.

An electronic device which establishes the first Internet PDN connection related to the first SIM may, in operation 713, perform a registration procedure with a second IMS connected to a second communication network (e.g., a second communication network 111b in FIG. 1B) based on the established first Internet PDN connection. The electronic device may perform the registration procedure with the second IMS via the first Internet PDN connection related to the first SIM without performing the registration procedure with the second IMS via at least one second RF path related to a second SIM (e.g., a second SIM 112 in FIG. 1B or 1C) used for attaching to the second communication network.

The electronic device which performs the registration procedure with the second IMS via the first Internet PDN connection related to the first SIM may release a second IMS PDN connection established between the second IMS and the electronic device via at least one second RF path related to the second SIM in operation 715. The second IMS PDN connection may represent an IMS PDN connection established between the second IMS and the electronic device, and in contrast, the first IMS PDN connection may represent an IMS PDN connection established between the first IMS and the electronic device. According to another embodiment, since the electronic device may perform the registration procedure with the second IMS via the first Internet PDN connection related to the first SIM, there may be no need to use the second IMS PDN connection established between the second IMS and the electronic device, so the second IMS PDN connection may be released.

Use of the at least one second RF path related to the second SIM may be turned off, thereby reducing (for example, minimizing) power consumption, preventing performance degradation due to a resource conflict between the at least one first RF path related to the first SIM and the at least one second RF path related to the second SIM, and preventing a call conflict between a call related to the first SIM and a call related to the second SIM.

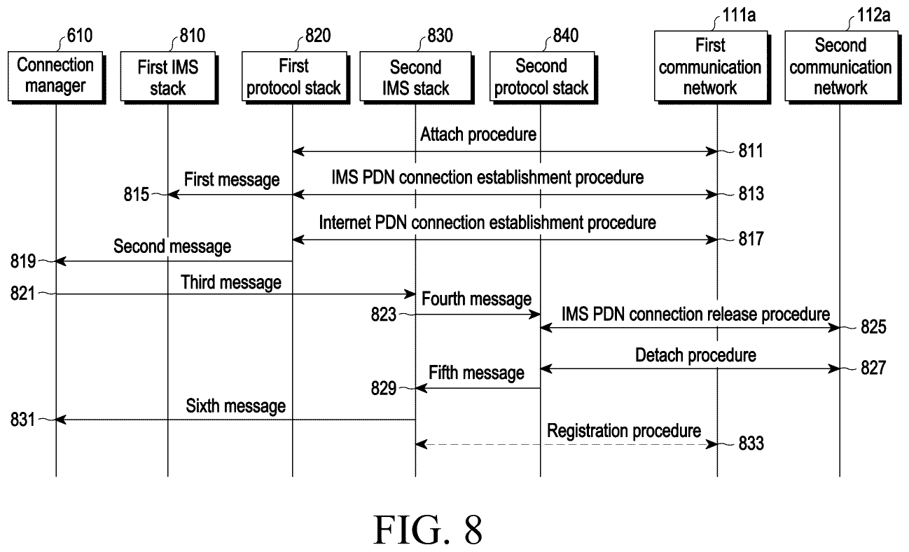

FIG. 8 is a signal flow diagram illustrating a PDN connection control operation in a wireless communication system according to an embodiment of the disclosure.

Referring to FIG. 8, an electronic device (e.g., an electronic device 101 in FIG. 1A, 1B, 1C, 2A, 2B, 3A, 3B, or 3C) may include at least two SIMs (e.g., a SIM1 and a SIM2). The SIM1 (e.g., a first SIM 111 in FIG. 1B or 1C) may be a DDS SIM, and the SIM2 (e.g., a second SIM 112 in FIG. 1B or 1C) may be a non-DDS SIM. The SIM1 may be a SIM used for attaching to a first communication network 111a (e.g., a first communication network 111a in FIG. 1B), and the SIM2 may be a SIM used for attaching to a second communication network 112a (e.g., a second communication network 112a in FIG. 1B).

The first communication network 111a may include an EPS (or a 5GS) and/or an EPC (or a 5GC) of a first communication carrier. The first communication network 111a may be connected to a first IMS (not illustrated in FIG. 8) which is an IMS of the first communication carrier. According to an embodiment, the second communication network 112a may include an EPS (or a 5GS) and/or an EPC (or a 5GC) of a second communication carrier. According to an embodiment, it may be connected to a second IMS (not illustrated in FIG. 8) which is an IMS of the second communication carrier.

The electronic device may include a connection manager 610 (e.g., a connection manager 610 in FIG. 6), a first IMS stack (entity) 810 (e.g., an IMS stack 511 in FIG. 5 or 6), a first protocol stack 820, a second IMS stack 830 (e.g., an IMS stack 517 in FIG. 5 or 6), and/or a second protocol stack 840.

The connection manager 610 may manage at least one connection related to the SIM1 and the SIM2. According to an embodiment, the at least one connection may include an IMS PDN connection and/or an Internet PDN connection related to the SIM1, and/or an IMS PDN connection and/or an Internet PDN connection related to the SIM2. According to an embodiment, the connection manager 610 may be included (or executed) in at least one of an application processor (e.g., a processor 120 in FIG. 1A, an application processor 120 in FIG. 1C, and a processor 120 in FIG. 2A or 2B) or a communication processor (e.g., the processor 120 in FIG. 1A, a communication processor 510 in FIG. 1C, a first communication processor 212 or a second communication processor 214 in FIG. 2A, and an integrated communication processor 260 in FIG. 2B).

According to an embodiment, the first IMS stack 810 may be an IMS stack related to the SIM1 and may perform an operation related to an IMS service. The first IMS stack 810 may be included (or executed) in at least one of the application processor or the communication processor.

The second IMS stack 830 may be an IMS stack related to the SIM2 and may perform an operation related to the IMS service. The second IMS stack 830 may be included (or executed) in the at least one of the application processor or the communication processor.

According to another embodiment, the first protocol stack 820 may be a protocol stack related to the SIM1 and may perform an operation according to various protocols. The first protocol stack 820 may be included (or executed) in the communication processor.

In an embodiment, the second protocol stack 840 may be a protocol stack related to the SIM2 and may perform an operation according to the various protocols. The second protocol stack 840 may be included (or executed) in the communication processor.

According to an embodiment, an attach procedure for each communication network may be performed independently in the electronic device. For example, an attach procedure for the first communication network 111a related to the SIM1 may be performed first, and then an attach procedure for the second communication network 112a related to the SIM2 may be performed. On the contrary, the attach procedure for the second communication network 112a related to the SIM2 may be performed first, and then the attach procedure for the first communication network 111a related to the SIM1 may be performed. In FIG. 8, it will be assumed that the attach procedure for the second communication network 112a related to the SIM2 which is a non-DDS SIM is performed first, and then the attach procedure for the first communication network 111a related to the SIM1 which is a DDS SIM is performed after the attach procedure for the second communication network 112a.

When the attach procedure for the second communication network 112a is completed and the IMS PDN connection used for the IMS service is established, the first protocol stack 820 may identify that an attach request for the first communication network 111a exists. Hereinafter, for convenience of a description, the PDN connection used for the IMS service will be referred to as an “IMS PDN connection.” The first protocol stack 820 may perform an attach procedure with the first communication network 111a in operation 811.

The first protocol stack 820 which performs the attach procedure with the first communication network 111a may, in operation 813, perform an IMS PDN connection establishment procedure with the first IMS via the first communication network 111a to establish an IMS PDN connection. The first protocol stack 820 may transfer information related to the IMS PDN connection established with the first communication network 111a to the first IMS stack 810 in operation 815. The first protocol stack 820 and the first IMS stack 810 may, for example, share the information related to the IMS PDN connection established between the first IMS and the electronic device. The IMS PDN connection established between the first IMS and the electronic device may be an IMS PDN connection related to the SIM1. The information related to the IMS PDN connection established with the first communication network 111a may be transferred via a first message, and the first message may be implemented in various formats and may not be limited to any one format.

The first protocol stack 820 which establishes the IMS PDN connection with the first IMS may perform an Internet PDN connection establishment procedure with the first communication network 111a to establish an Internet PDN connection in operation 817. The first protocol stack 820 may transfer, to the connection manager 610, information related to the IMS PDN connection established between the electronic device and the first IMS and/or information related to the Internet PDN connection established between the electronic device and the first communication network 111a in operation 819. The Internet PDN connection established between the electronic device and the first communication network 111a may be an Internet PDN connection related to the SIM1. The information related to the Internet PDN connection established between the electronic device and the first communication network 111a may be transferred via a second message, and the second message may be implemented in various formats and may not be limited to any one format. A format of a message including the information related to the Internet PDN connection established between the electronic device and the first communication network 111a will be described below with reference to FIG. 9, so a detailed description thereof will be omitted herein.

The information related to the Internet PDN connection established between the electronic device and the first communication network 111a may include first information indicating a RAT related to the SIM1, second information indicating a service state of the Internet PDN connection related to the SIM1, an IP address obtained when the Internet PDN connection is established, and/or an IP address of a DNS server obtained when the Internet PDN connection is established. According to an embodiment, the RAT may include, but is not limited to, a technology, and/or an NR technology. According to an embodiment, the service state may indicate that the Internet PDN connection is available.

The connection manager 610 which identifies the information related to the Internet PDN connection related to the SIM1 may transfer a third message to the second IMS stack 830 in operation 821. The third message may include the information related to the Internet PDN connection related to the SIM1. The information related to the Internet PDN connection related to the SIM1 included in the third message may be implemented to be similar to or substantially the same as the information related to the Internet PDN connection related to the SIM1 included in the second message, so a detailed description thereof will be omitted herein.

The second IMS stack 830 which receives the third message from the connection manager 610 may identify whether there is a need to maintain (or establish) the IMS PDN connection related to the SIM2 based on the information related to the Internet PDN connection related to the SIM1 included in the third message in operation 823. According to an embodiment, the second IMS stack 830 may identify that there is no need to maintain (or establish) the IMS PDN connection related to the SIM2 if a set condition is satisfied. According to another embodiment, the second IMS stack 830 may identify that there is a need to maintain (or establish) the IMS PDN connection related to the SIM2 if the set condition is not satisfied.

According to an embodiment, the set condition may include a first condition that a WiFi connection is possible, and/or a second condition that the Internet PDN connection related to the SIM1 exists.

According to an embodiment, the second IMS stack 830 may identify that there is no need to maintain (or establish) the IMS PDN connection related to the SIM2 if the set condition is satisfied, may determine to release the IMS PDN connection related to the SIM2, and may transfer, to the second protocol stack 840, a fourth message indicating that the IMS PDN connection related to the SIM2 is unnecessary in operation 823. The fourth message may be a message related to usability of an IMS PDN connection. The fourth message may be implemented in various formats and may not be limited to any one format.

The second protocol stack 840 which receives the fourth message from the second IMS stack 830 may identify that there is the need to release the IMS PDN connection related to the SIM2 established between the electronic device and the second IMS, based on the received fourth message. The second protocol stack 840 which identifies that there is the need to release the IMS PDN connection related to the SIM2 may perform an IMS PDN connection release procedure with the second IMS to release the IMS PDN connection established between the electronic device and the second IMS in operation 825.

The second protocol stack 840 may perform a detach procedure with the second communication network 112a after releasing the IMS PDN connection related to the SIM2 in operation 827. The second protocol stack 840 which performs the detach procedure with the second communication network 112a may turn off at least one second RF path related to the SIM2 or lower a priority of an operation related to the SIM2.

The second protocol stack 840 which performs the detach procedure with the second communication network 112a may transfer information indicating that an attachment to the second communication network 112a is released to the second IMS stack 830 in operation 829. The information indicating that the attachment to the second communication network 112a is released may be transferred via a fifth message. The fifth message may be implemented in various formats and may not be limited to any one format.

Since the IMS PDN connection related to the SIM2 is released and the attachment to the second communication network 112a is released, the second IMS stack 830 may transfer a sixth message to the connection manager 610 in operation 831. The sixth message may be a connection request message, and the connection request message may be a message for requesting to establish the IMS PDN connection related to the SIM2 via the Internet PDN connection related to the SIM1. The sixth message may be implemented in various formats and may not be limited to any one format.

The second IMS stack 830 which transfers the sixth message may perform a registration procedure for the second IMS related to the SIM2 via the Internet PDN connection related to the SIM1 via the first protocol stack 820 in operation 833. The second IMS stack 830 has already identified, via the connection manager 610, the information related to the Internet PDN connection established between the first communication network 111a and the electronic device and the information related to the IMS PDN connection established between the first IMS and the electronic device, and therefore may perform the registration procedure with the second IMS based on the information related to the Internet PDN connection established between the first communication network 111a and the electronic device (e.g., the information related to the Internet PDN connection related to the SIM1). According to another embodiment, the information related to the Internet PDN connection related to the SIM1 may include an IP address allocated to the electronic device. The second IMS stack 830 may perform an IMS registration procedure with the second IMS connected to the second communication network 112a using a bearer of the Internet PDN connected between the electronic device and the first communication network 111a (for example, using a corresponding network).

According to an embodiment, the second protocol stack 840 may remain in a suspend state in layers below a radio resource control (RRC) layer or in the RRC layer if a packet service charge for the SIM1 which is the DDS SIM is free or a charge for a WiFi service is free. According to an embodiment, the second protocol stack 840 may turn off use of the at least one second RF path related to the SIM2 by deactivating (for example, by turning off) an RF circuit (e.g., an RF circuit 520 in FIG. 1C), thereby reducing (for example, minimizing) power consumption, preventing performance degradation due to a resource conflict between the at least one first RF path related to the SIM1 and the at least one second RF path related to the SIM2, and preventing a call conflict between a call related to the SIM1 and a call related to the SIM2. If the packet service charge for the SIM1 which is the DDS SIM is not free and/or the charge for the WiFi service is not free, the second protocol stack 840 (1) may use the longest period among periods of a call monitoring operation specified in the wireless communication system for a call monitoring operation related to the SIM2 which is the non-DDS SIM, (2) if there is a call related to the SIM2, may not transfer it to a NAS layer, (3) if there is an outgoing call, may establish an Internet PDN connection related to the SIM2, and connect the outgoing call via the Internet PDN connection related to the SIM2, (4) if there is an incoming call, may establish an Internet PDN connection related to the SIM2, and connect the incoming call via the Internet PDN connection related to the SIM2 (for example, 180 ringing transmission may be performed after the Internet PDN connection related to the SIM2 is established), and (5) after connecting all of the outgoing call and/or the incoming call via the Internet PDN connection related to the SIM1, may establish an Internet PDN connection related to the SIM2, and connect the outgoing call and/or the incoming call via the Internet PDN connection related to the SIM2.

In FIG. 8, the PDN connection control operation in a case that the electronic device includes the two SIMs has been described as an example, and the operation related to the non-DDS SIM (e.g., the operation related to the non-DDS SIM according to sharing of the Internet PDN connection of the DDS SIM) has been described, however, even if the electronic device includes only one SIM, the RF circuit may operate similarly to the operation related to the non-DDS SIM described in FIG. 8. If the electronic device is a single SIM electronic device including one SIM and supports a plurality of RF paths, the electronic device may provide a specific service via an Internet PDN connection established via one of the plurality of RF paths, and may also provide other services via the Internet PDN connection set for the specific service. In this case, the RF circuit may operate similarly to the operation related to the non-DDS SIM for other services corresponding to the remaining RF paths, excluding the RF path on which the Internet PDN connection is set.

FIG. 9 is a diagram schematically illustrating a format of a message including information related to an Internet PDN connection established between an electronic device and a first communication network according to an embodiment of the disclosure.

Referring to FIG. 9, a message including information related to an Internet PDN connection established between an electronic device (e.g., an electronic device 101 in FIG. 1A, 1B, 1C, 2A, 2B, 3A, 3B, or 3C) and a first communication network (e.g., a first communication network 111a in FIG. 1B) may include a service state field 911, an RAT field 913, an IP address field 915, and/or a DNS server address field 917.

According to an embodiment, the message including the information related to the Internet PDN connection established between the electronic device and the first communication network may include information related to an Internet PDN connection related to a SIM1 (e.g., a first SIM 111 in FIG. 1B or 1C). According to another embodiment, the message including the information related to the Internet PDN connection established between the electronic device and the first communication network may include first information indicating a RAT related to the SIM1, second information indicating a service state of the Internet PDN connection related to the SIM1, an IP address obtained when the Internet PDN connection is established, and/or an IP address of a DNS server obtained when the Internet PDN connection is established. According to an embodiment, the RAT may include, but is not limited to, a technology, and/or an NR technology. The service state may indicate that the Internet PDN connection is available.

The service state field 911 may include the second information.

According to an embodiment, the RAT field 913 may include the first information. The first information may indicate one of an LTE technology or an NR technology. In an embodiment, the RAT related to the SIM1 may include, but is not limited to, the LTE technology and/or the NR technology.

According to an embodiment, the IP address field 915 may include the IP address obtained when the Internet PDN connection related to the SIM1 is established.

The DNS server address field 917 may include the address of the DNS server (e.g., an IP address of the DNS server) obtained when the Internet PDN connection related to the SIM1 is established.

According to another embodiment, the message including the information related to the Internet PDN connection established between the electronic device and the first communication network may be implemented in various formats and may not be limited to a format illustrated in FIG. 9.

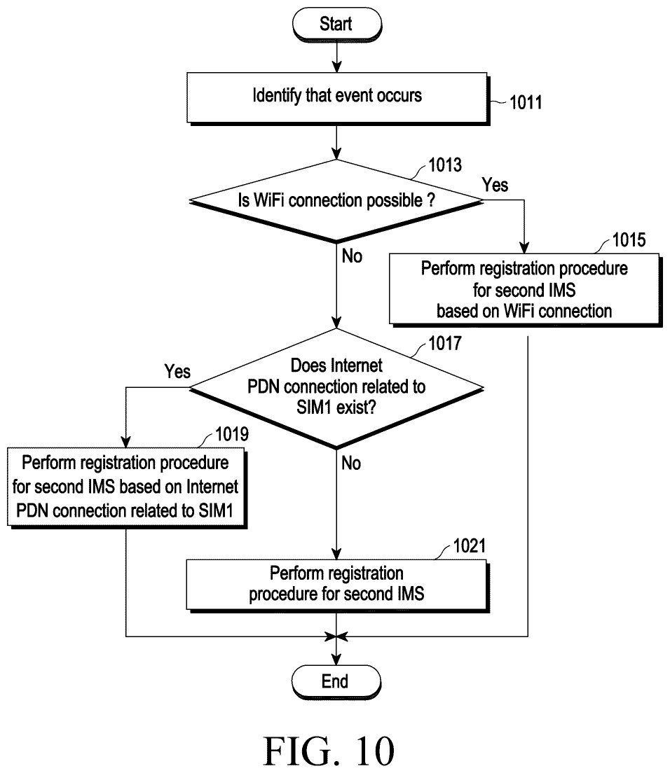

FIG. 10 is a flowchart illustrating an operating process of an electronic device according to an embodiment of the disclosure.

Prior to a description of FIG. 10, an electronic device (e.g., an electronic device 101 in FIG. 1A, 1B, 1C, 2A, 2B, 3A, 3B, or 3C) may include at least two SIMs (e.g., a SIM1 and a SIM2). The SIM1 (e.g., a first SIM 111 in FIG. 1B or 1C) may be a DDS SIM, and the SIM2 (e.g., a second SIM 112 in FIG. 1B or 1C) may be a non-DDS SIM. The SIM1 may be a SIM used for attaching to a first communication network (e.g., a first communication network 111a in FIG. 8 or 1B), and the SIM2 may be a SIM used for attaching to a second communication network (e.g., a second communication network 112a in FIG. 8 or 1B.

Referring to FIG. 10, an electronic device an electronic device (e.g., an electronic device 101 in FIG. 1A, 1B, 1C, 2A, 2B, 3A, 3B, or 3C) (e.g., a processor 120 in FIG. 1A, an application processor 120 in FIG. 1C, a processor 120 in FIG. 2A or 2B, a communication processor 510 in FIG. 1C, a first communication processor 212 or a second communication processor 214 in FIG. 2A, or an integrated communication processor 260 in FIG. 2B) may identify that an event in which there is a need to perform an IMS registration procedure related to the SIM2 occurs in operation 1011. According to an embodiment, the electronic device may identify that the event in which there is a need to perform a registration procedure with an IMS related to the SIM2 occurs.

The electronic device which identifies that the event in which there is the need to perform the registration procedure with a second IMS occurs may identify whether a WiFi connection is possible in operation 1013.

As a result of the identification, if the WiFi connection is possible, the electronic device may perform the registration procedure for the second IMS based on the WiFi connection in operation 1015.

As the result of the identification in operation 1013, if the WiFi connection is not possible, the electronic device may identify whether an Internet PDN connection related to the SIM1 exists in operation 1017. As a result of the identification, if the Internet PDN connection related to the SIM1 exists, the electronic device may perform a registration procedure for the second IMS based on the Internet PDN connection related to the SIM1 in operation 1019. According to an embodiment, an RAT related to the Internet PDN connection related to the SIM1 may include an LTE technology and/or an NR technology. The Internet PDN connection related to the SIM1 may have received signal strength greater than or equal to threshold received signal strength. According to an embodiment, the received signal strength may include at least one of reference signal received power (RSRP), a received strength signal indicator (RSSI), reference signal received quality (RSRP), reference signal code power (RSCP), a signal to noise ratio (SNR), or a signal to interference plus noise ratio (SINR).

The electronic device which performs the registration procedure with the second IMS via the Internet PDN connection related to the SIM1 may turn off use of the at least one second RF path related to the SIM2, thereby reducing (for example, minimizing) power consumption, preventing performance degradation due to a resource conflict between the at least one first RF path related to the SIM1 and the at least one second RF path related to the SIM2, and preventing a call conflict between a call related to the SIM1 and a call related to the SIM2.

As the result of the identification in operation 1017, if the Internet PDN connection related to the SIM1 does not exist, the electronic device may perform a registration procedure with the second IMS via the at least one second RF path related to the SIM2 in operation 1021.

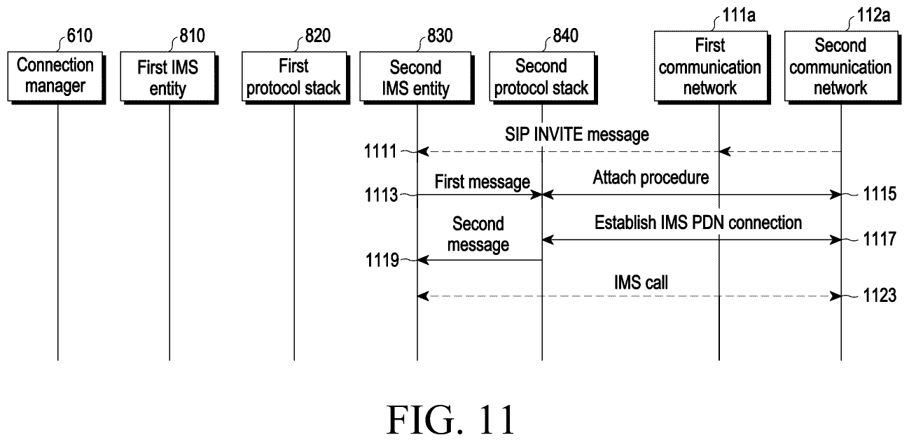

FIG. 11 is a signal flow diagram illustrating a PDN connection control operation in a wireless communication system according to an embodiment of the disclosure.

Referring to FIG. 11, an electronic device (e.g., an electronic device 101 in FIG. 1A, 1B, 1C, 2A, 2B, 3A, 3B, or 3C) may include at least two SIMs (e.g., a SIM1 and a SIM2). The SIM1 (e.g., a first SIM 111 in FIG. 1B or 1C) may be a DDS SIM, and the SIM2 (e.g., a second SIM 112 in FIG. 1B or 1C) may be a non-DDS SIM. The SIM1 may be a SIM used for attaching to a first communication network 111a (e.g., a first communication network 111a in FIG. 1B), and the SIM2 may be a SIM used for attaching to a second communication network 112a (e.g., a second communication network 112a in FIG. 1B).

According to an embodiment, the first communication network 111a may include an EPS (or a 5GS) and/or an EPC (or a 5GC) of a first communication carrier. The first communication network 111a may be connected to a first IMS (not illustrated in FIG. 11) which is an IMS of the first communication carrier. According to another embodiment, the second communication network 112a may include an EPS (or a 5GS) and/or an EPC (or a 5GC) of a second communication carrier. According to an embodiment, it may be connected to a second IMS (not illustrated in FIG. 11) which is an IMS of the second communication carrier.

The electronic device may include a connection manager 610 (e.g., a connection manager 610 in FIG. 6 or 8), a first IMS stack (entity) 810 (e.g., an IMS stack 511 in FIG. 5 or 6, or a first IMS stack 810 in FIG. 8), a first protocol stack 820 (e.g., a first protocol stack 820 in FIG. 8), a second IMS stack 830 (e.g., an IMS stack 517 in FIG. 5 or 6, or a second IMS stack 830 in FIG. 8), and/or a second protocol stack 840 (e.g., a second protocol stack 840 in FIG. 8).

The connection manager 610 may manage at least one connection related to the SIM1 and the SIM2. According to an embodiment, the at least one connection may include an IMS PDN connection and/or an Internet PDN connection related to the SIM1, and/or an IMS PDN connection and/or an Internet PDN connection related to the SIM2. According to an embodiment, the connection manager 610 may be included (or executed) in at least one of an application processor (e.g., a processor 120 in FIG. 1A, an application processor 120 in FIG. 1C, and a processor 120 in FIG. 2A or 2B) or a communication processor (e.g., the processor 120 in FIG. 1A, a communication processor 510 in FIG. 1C, a first communication processor 212 or a second communication processor 214 in FIG. 2A, and an integrated communication processor 260 in FIG. 2B).

According to an embodiment, the first IMS stack 810 may be an IMS stack related to the SIM1 and may perform an operation related to an IMS service. The first IMS stack 810 may be included (or executed) in at least one of the application processor or the communication processor.

According to another embodiment, the second IMS stack 830 may be an IMS stack related to the SIM2 and may perform an operation related to the IMS service. The second IMS stack 830 may be included (or executed) in the at least one of the application processor or the communication processor.

In an embodiment, the first protocol stack 820 may be a protocol stack related to the SIM1 and may perform an operation according to various protocols. The first protocol stack 820 may be included (or executed) in the communication processor.

According to another embodiment, the second protocol stack 840 may be a protocol stack related to the SIM2 and may perform an operation according to the various protocols. The second protocol stack 840 may be included (or executed) in the communication processor.

The connection control operation illustrated in FIG. 11 may be a PDN connection control operation in a case that an incoming call (mobile terminated call (MT call)) (e.g., an IMS call) related to the SIM2 starts.

The second IMS stack 830 may, in operation 1111, identify that an IMS call related to the SIM2 exists when receiving a Session Initiation Protocol (SIP) invite message from the second IMS via a connection related to the SIM1 (e.g., an Internet PDN connection related to the SIM1). Hereinafter, for convenience of a description, the IMS call related to the SIM2 will be referred to as a “SIM2 IMS call.” The second IMS stack 830 which identifies that the SIM2 IMS call exists may determine to process the SIM2 IMS call via a connection related to the SIM2 (e.g., an Internet PDN connection related to the SIM2 and/or an IMS PDN connection related to the SIM2) in which quality of service (QoS) is guaranteed as IMS call processing is required. In FIG. 11, the PDN connection control operation in the case that the SIM2 IMS call exists will be described as an example, but a PDN connection control operation in a case that an outgoing call (a mobile originated call (MO call)) related to the SIM2 exists may also be performed similar to or substantially the same as the PDN connection control operation in the case that the MT call related to the SIM2 exists.

The second IMS stack 830 which identifies that the SIM2 IMS call exists may transfer, to the second protocol stack 840, a first message indicating that an IMS PDN connection related to the SIM2 is required, and may adjust a priority for an operation related to the SIM2 (for example, may increase the priority for the operation related to SIM2) in operation 1113. The first message may be implemented in various formats and is not limited to any one format.

Since the RF path related to the SIM2 is turned off, the second protocol stack 840 which receives the first message indicating that the IMS PDN connection related to the SIM2 is required may turn on the RF path related to the SIM2, and perform an attach procedure with the second communication network 112a to establish the Internet PDN connection related to the SIM2 in operation 1115.

The second protocol stack 840 which performs the attach procedure with the second communication network 112a may establish an IMS PDN connection between the electronic device and the second IMS via the second communication network 112a and perform a registration procedure with the second IMS based on the established IMS PDN connection in operation 1117.

The second protocol stack 840 may transfer information related to the IMS PDN connection established between the electronic device and the second IMS to the second IMS stack 830 in operation 1119. According to an embodiment, the second protocol stack 840 may transfer, to the connection manager 610, information indicating that the IMS PDN connection established between the electronic device and the second IMS is an IMS PDN connection of a handover (HO) type generated according to IMS call processing. The information indicating that the IMS PDN connection established between the electronic device and the second IMS is the IMS PDN connection of the HO type generated according to the IMS call processing may be transferred via a second message. The second message may be, for example, implemented in various formats and is not limited to any one format. According to an embodiment, the IMS PDN connection of the HO type may be an IMS PDN connection established for processing a corresponding IMS call, and may be an IMS PDN connection released if the processing for the corresponding IMS call is completed.

The second protocol stack 840 may transfer, to the connection manager 610, the information related to the IMS PDN connection of the HO type established between the electronic device and the second IMS in operation 1121. In an embodiment, the information related to the IMS PDN connection of the HO type established between the electronic device and the second IMS may be transferred via a third message. The third message may be implemented in various formats and is not limited to any one format.

The second IMS stack 830 may process a SIM2 IMS call via the IMS PDN connection established with the second IMS (e.g., an IMS PDN connection of the HO type related to the SIM2) in operation 1123.

Although not illustrated separately in FIG. 11, as the IMS PDN connection is established between the electronic device and the second IMS, the second IMS entity 830 may transmit information indicating that a registration procedure is performed with the second IMS to the connection manager 610 via the second communication protocol stack 840, and the connection manager 610 may recognize that the registration procedure is performed with the second IMS.

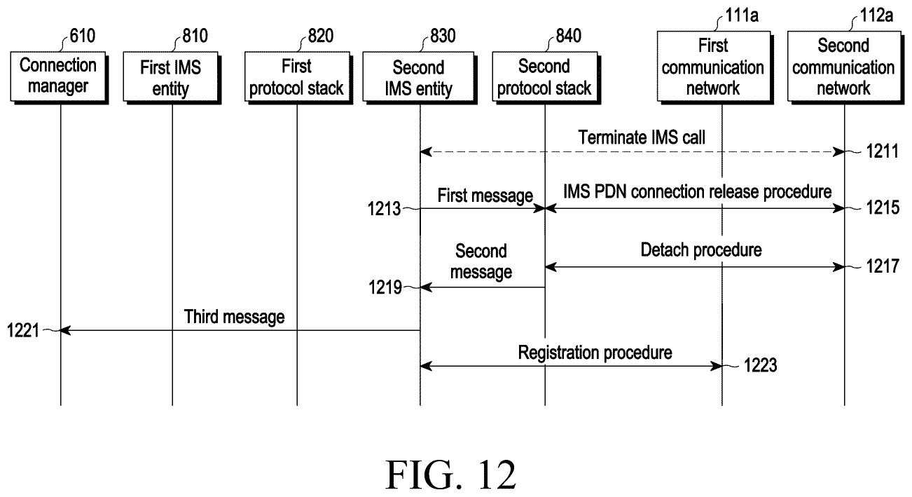

FIG. 12 is a signal flow diagram illustrating a PDN connection control operation in a wireless communication system according to an embodiment of the disclosure.

Referring to FIG. 12, an electronic device (e.g., an electronic device 101 in FIG. 1A, 1B, 1C, 2A, 2B, 3A, 3B, or 3C) may include at least two SIMs (e.g., a SIM1 and a SIM2). The SIM1 (e.g., a first SIM 111 in FIG. 1B or 1C) may be a DDS SIM, and the SIM2 (e.g., a second SIM 112 in FIG. 1B or 1C) may be a non-DDS SIM. The SIM1 may be a SIM used for attaching to a first communication network 111a (e.g., a first communication network 111a in FIG. 1B), and the SIM2 may be a SIM used for attaching to a second communication network 112a (e.g., a second communication network 112a in FIG. 1B).

According to an embodiment, the first communication network 111a may include an EPS (or a 5GS) and/or an EPC (or a 5GC) of a first communication carrier. The first communication network 111a may be connected to a first IMS (not illustrated in FIG. 12) which is an IMS of the first communication carrier. According to an embodiment, the second communication network 112a may include an EPS (or a 5GS) and/or an EPC (or a 5GC) of a second communication carrier. According to an embodiment, it may be connected to a second IMS (not illustrated in FIG. 12) which is an IMS of the second communication carrier.

The electronic device may include a connection manager 610 (e.g., a connection manager 610 in FIG. 6, 8, or 11), a first IMS stack (entity) 810 (e.g., an IMS stack 511 in FIG. 5 or 6, or a first IMS stack 810 in FIG. 8), a first protocol stack 820 (e.g., a first protocol stack 820 in FIG. 8 or 11), a second IMS stack 830 (e.g., an IMS stack 517 in FIG. 5 or 6, or a second IMS stack 830 in FIG. 8 or 11), and/or a second protocol stack 840 (e.g., a second protocol stack 840 in FIG. 8 or 11).

According to another embodiment, the connection manager 610 may manage at least one connection related to the SIM1 and the SIM2. According to an embodiment, the at least one connection may include an IMS PDN connection and/or an Internet PDN connection related to the SIM1, and/or an IMS PDN connection and/or an Internet PDN connection related to the SIM2. According to an embodiment, the connection manager 610 may be included (or executed) in at least one of an application processor (e.g., a processor 120 in FIG. 1A, an application processor 120 in FIG. 1C, and a processor 120 in FIG. 2A or 2B) or a communication processor (e.g., the processor 120 in FIG. 1A, a communication processor 510 in FIG. 1C, a first communication processor 212 or a second communication processor 214 in FIG. 2A, and an integrated communication processor 260 in FIG. 2B).

In yet another embodiment, the first IMS stack 810 may be an IMS stack related to the SIM1 and may perform an operation related to an IMS service. The first IMS stack 810 may be included (or executed) in at least one of the application processor or the communication processor.

According to an embodiment, the second IMS stack 830 may be an IMS stack related to the SIM2 and may perform an operation related to the IMS service. The second IMS stack 830 may be included (or executed) in the at least one of the application processor or the communication processor.

The first protocol stack 820 may be a protocol stack related to the SIM1 and may perform an operation according to various protocols. The first protocol stack 820 may be included (or executed) in the communication processor.

According to an embodiment, the second protocol stack 840 may be a protocol stack related to the SIM2 and may perform an operation according to the various protocols. The second protocol stack 840 may be included (or executed) in the communication processor.

The connection control operation illustrated in FIG. 12 may be a connection control operation in a case that a SIM2 IMS call is terminated.

The second IMS stack 830 may, in operation 1211, terminate a SIM2 IMS call being performed with the second IMS via an IMS PDN connection of a HO type. As the SIM2 IMS call being performed via the IMS PDN connection of the HO type is terminated, the second IMS stack 830 may transfer, to the second protocol stack 840, a first message including information indicating that there is no need for the IMS PDN connection (e.g., the IMS PDN connection of the HO type) related to the second SIM in operation 1213. The first message may be implemented in various formats and is not limited to any one format.

The second protocol stack 840 which receives, from the second IMS stack 830, the first message including the information indicating that there is no need for the IMS PDN connection (e.g., the IMS PDN connection of the HO type) related to the second SIM may release the IMS PDN connection (e.g., the IMS PDN connection of the HO type) related to the second SIM which is established with the second IMS in operation 1215.

The second protocol stack 840 may, for example, perform a detach procedure with the second communication network 112a after releasing the IMS PDN connection of the HO type related to the SIM2 in operation 1217. According to an embodiment, the second protocol stack 840 may turn off an RF path related to the SIM2 or lower a priority of an operation related to the SIM2.

The second protocol stack 840 which performs the detach procedure with the second communication network 112a may transfer, to the second IMS stack 830, information indicating that an attachment to the second communication network 112a is released in operation 1219. The information indicating that the attachment to the second communication network 112a is released may be transferred via a second message. The second message may be implemented in various formats and is not limited to any one format.

Since the IMS PDN connection related to the SIM2 is released and the attachment to the second communication network 112a is released, the second IMS stack 830 may transfer, to the connection manager 610, a third message for requesting to establish the IMS PDN connection related to the SIM2 via an Internet PDN connection related to the SIM1 in operation 1221. The third message may be, for example, a connection request message, and the connection request message may be a message for requesting the IMS PDN connection related to the SIM2 via the Internet PDN connection related to the SIM1. The third message may be implemented in various formats and is not limited to any one format.

The second IMS stack 830 which transfers the third message may perform a registration procedure with the second IMS via the Internet PDN connection related to the SIM1 via the first protocol stack 820 in operation 1223.

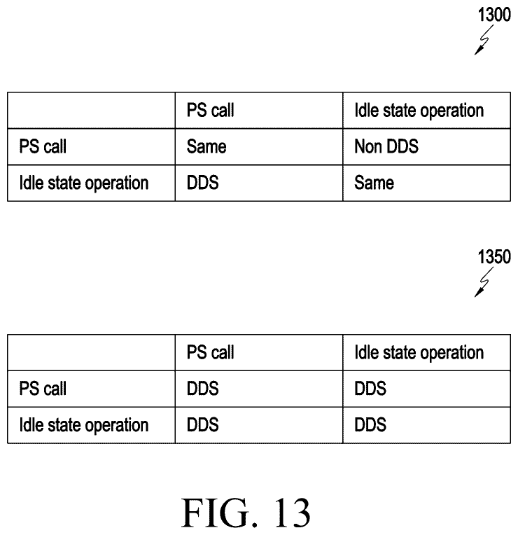

FIG. 13 is a diagram for explaining an operation according to a priority between SIMs according to an embodiment of the disclosure.

Referring to FIG. 13, an electronic device (e.g., an electronic device 101 in FIG. 1A, 1B, 1C, 2A, 2B, 3A, 3B, or 3C) may include at least two SIMs (e.g., a SIM1 and a SIM2). The SIM1 (e.g., a first SIM 111 in FIG. 1B or 1C) may be a DDS SIM, and the SIM2 (e.g., a second SIM 112 in FIG. 1B or 1C) may be a non-DDS SIM. The SIM1 may be a SIM used for attaching to a first communication network (e.g., a first communication network 111a in FIG. 1B), and the SIM2 may be a SIM used for attaching to a second communication network (e.g., a second communication network 112a in FIG. 1B).

According to an embodiment, in the electronic device, a non-access stratum (NAS) operation, a radio resource control (RRC) operation, and/or a layer 1 (L1) operation may be performed based on priorities for the SIM1 and the SIM2. According to an embodiment, a NAS operation, an RRC operation, and/or an L1 operation related to the SIM1 and a NAS operation, an RRC operation, and/or an L1 operation related to the SIM2 may be performed based on a priority.

Referring to FIG. 13, in a table 1300, a horizontal axis may represent a priority for a packet switched (PS) call and an idle state operation related to the DDS SIM, and a vertical axis may represent a priority for a PS call and an idle state (e.g., an RRC idle (RRC IDLE) state) operation related to the non-DDS SIM. In a table 1350, a horizontal axis may represent a priority for a PS call and an idle state operation related to the DDS SIM, and a vertical axis may represent a priority for a PS call and an idle state operation related to the non-DDS SIM.

Generally, a priority for an RF circuit for data transmission may be higher than a priority for an RF circuit (e.g., an RF circuit 520 in FIG. 1C) for an idle state operation. A priority for the RF circuit may represent a priority for using the RF circuit. The idle state operation may include a monitoring operation for a call signal and/or a cell measurement operation.

As illustrated in the table 1300, if the SIM1 (e.g., the DDS SIM) is related to data transmission (e.g., a PS call) and the SIM2 (e.g., the non-DDS SIM) is related to the idle state operation, a priority for an RF circuit related to the SIM2 may be higher.

According to an embodiment, if an IMS registration procedure is performed with the SIM2 via the Internet PDN connection related to the SIM1, as illustrated in the table 1350, a priority for an RF circuit related to the SIM1 may be higher than a priority for an RF circuit related to the SIM2, even if the SIM2 is related to the idle state operation. Stable use of an RF circuit may be guaranteed with respect to the SIM1.

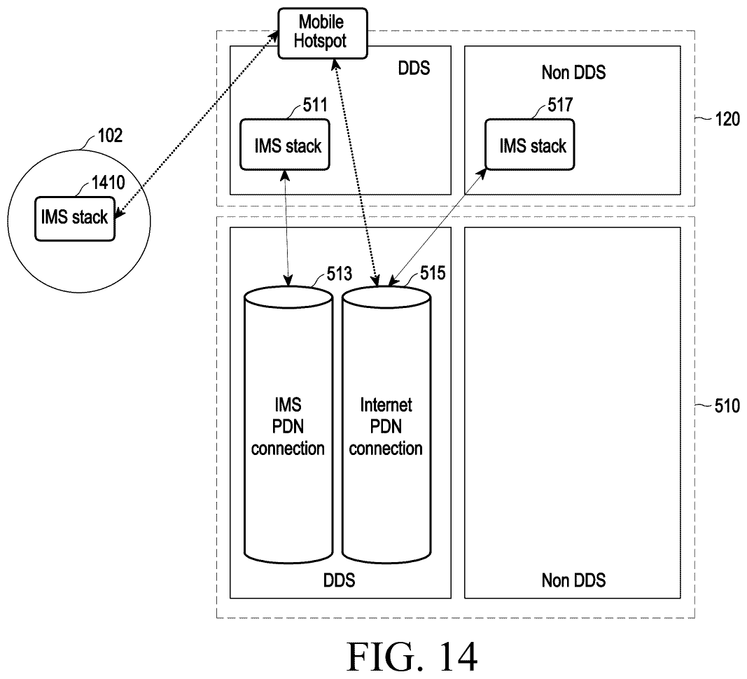

FIG. 14 is a diagram for explaining a PDN connection control operation in a wireless communication system according to an embodiment of the disclosure.

Referring to FIG. 14, an electronic device an electronic device (e.g., an electronic device 101 in FIG. 1A, 1B, 1C, 2A, 2B, 3A, 3B, or 3C) may include an application processor 120 (e.g., a processor 120 in FIG. 1A, an application processor 120 in FIG. 1C, or a processor 120 in FIG. 2A or 2B) and/or a communication processor 510 (e.g., a communication processor 510 in FIG. 1C, a first communication processor 212 or a second communication processor 214 in FIG. 2A, or an integrated communication processor 260 in FIG. 2B). The application processor 120 and the communication processor 510 may be implemented as separate hardware. In another implementation example, the application processor 120 and the communication processor 510 may be implemented in a single chip, and there is no limitation on a form of implementation.

If the electronic device includes two SIMs (e.g., a SIM1 and a SIM2), the SIM1 (e.g., a first SIM 111 in FIG. 1B or 1C) may be a DDS SIM, and the SIM2 (e.g., a second SIM 112 in FIG. 1B or 1C) may be a non-DDS SIM.

According to another embodiment, the application processor 120 may include an IMS stack 511 related to the DDS SIM (e.g., an IMS stack 511 in FIG. 5 or 6, or a first IMS stack 810 in FIG. 8, 11, or 12), an IMS stack 517 related to the non-DDS SIM (e.g., an IMS stack 517 in FIG. 5 or 6, or a second IMS stack 830 in FIG. 8, 11, or 12), and/or a connection manager 610 (e.g., a connection manager 610 in FIG. 6, 8, 11, or 12). In FIG. 14, a case that the IMS stack 511, the IMS stack 517, and/or the connection manager 610 are included (or executed) in the application processor 120 has been described as an example, however, the IMS stack 511, the IMS stack 517, and/or the connection manager 610 may also be included (or executed) in the communication processor 510.

The IMS stack 511 and the IMS stack 517 may be implemented to be similar to or substantially the same as those described in FIG. 5, so a detailed description thereof will be omitted herein.

According to an embodiment, similarly to a scheme in which an IMS service related to the non-DDS SIM is provided via an Internet PDN connection related to the DDS SIM, an IMS service may be provided with an electronic device (102) (e.g., an electronic device 102 in FIG. 1) (e.g., a wearable electronic device or an IoT device) via an Internet PDN connection related to the DDS SIM. The electronic devices 102 may include an IMS stack 1410, and the IMS stack 1410 may perform an operation related to an IMS service related to the electronic device 102.

The electronic device 102 may be connected to the electronic device 101 providing an Internet PDN connection 515 via a WiFi connection, and may share the Internet PDN connection 515. If the WiFi connection is possible via a mobile hotspot, an IMS service and an Internet service may be provided to the electronic device 102 via the electronic device 101. In this case, the electronic device 102 may turn off at least one RF path which is supportable in the electronic device 102 to reduce (for example, minimize) current consumption. The electronic device 102 may receive the IMS service and the Internet service via the Internet PDN connection 515 of the electronic device 101 if received signal strength thereof is lower than threshold received signal strength, or if the electronic device 102 uses transmission power higher than or equal to threshold transmission power in RRC_CONNECTED even though the electronic device 102 exists in an RRC_IDLE state, or exists in an RRC connected (RRC_CONNECTED) state. According to an embodiment, the received signal strength may include at least one of RSRP, an RSSI, RSRQ, RSCP, an SNR, or an SINR.

In FIG. 14, the PDN connection control operation has been described using a separate electronic device such as the electronic device 102, other than the electronic device 101 as an example, but if the electronic device 101 uses three or more SIMs, the IMS service and the Internet service may be provided via the Internet PDN connection 515 of the electronic device 101 in the same scheme as described in FIG. 14 for the three or more SIMs based on a hotspot scheme.

According to an embodiment, a method of operating an electronic device (e.g., an electronic device 101 in FIG. 1A, 1B, 1C, 2A, 2B, 3A, 3B, or 3C) may include establishing (711) a first Internet packet data network (PDN) connection related to a first subscriber identity module (SIM) (e.g., a first SIM 111 in FIG. 1B or 1C) by performing an attach procedure with a first communication network (e.g., a first communication network 111a in FIG. 1B) via at least one first radio frequency (RF) path related to the first subscriber identity module (SIM) (e.g., the first SIM 111 in FIG. 1B or 1C) used for attaching to the first communication network (e.g., the first communication network 111a in FIG. 1B) among a plurality of RF paths supportable in the electronic device (e.g., the electronic device 101 in FIG. 1A, 1B, 1C, 2A, 2B, 3A, 3B, or 3C).

According to another embodiment, the method may further include, based on the first Internet PDN connection, performing (713) a registration procedure with a second Internet protocol (IP) multimedia subsystem (IMS) connected to a second communication network (e.g., a second communication network 112a in FIG. 1B) related to a second SIM (e.g., a second SIM 112 in FIG. 1B or 1C).

According to an embodiment, performing the registration procedure with the second IMS based on the first Internet PDN connection may include performing the registration procedure for the second IMS based on an IP address related to the first Internet PDN connection, an IP address of a domain name system (DNS) server, or a radio access technology (RAT) used in the first communication network (e.g., the first communication network 111a in FIG. 1B).

According to an embodiment of the disclosure, the method may further include releasing (715) a second IMS PDN connection related to the second SIM (e.g., the second SIM 112 in FIG. 1B or 1C) which is established between the second IMS and the electronic device (e.g., the electronic device 101 in FIG. 1A, 1B, 1C, 2A, 2B, 3A, 3B, or 3C) via at least one second RF path related to the second SIM (e.g., the second SIM 112 in FIG. 1B or 1C) among the plurality of RF paths.

According to another embodiment of the disclosure, the method may further include releasing a second Internet PDN connection related to the second SIM (e.g., the second SIM 112 in FIG. 1B or 1C) which is established between the second communication network (e.g., the second communication network 112a in FIG. 1B) and the electronic device (e.g., the electronic device 101 in FIG. 1A, 1B, 1C, 2A, 2B, 3A, 3B, or 3C) via the at least one second RF path related to the second SIM (e.g., the second SIM 112 in FIG. 1B or 1C) among the plurality of RF paths.

According to yet another embodiment of the disclosure, the method may further include, via the first IMS PDN connection established between the first IMS connected to the first communication network (e.g., the first communication network 111a in FIG. 1B) and the electronic device (e.g., the electronic device 101 in FIG. 1A, 1B, 1C, 2A, 2B, 3A, 3B, or 3C), identifying that an IMS call related to the second SIM (e.g., the second SIM 112 in FIG. 1B or 1C) from the second IMS exits.

The method may further include, via the at least one second RF path, establishing the second IMS PDN connection related to the second SIM (e.g., the second SIM 112 in FIG. 1B or 1C).

According to an embodiment of the disclosure, the method may further include, based on the second IMS PDN connection, performing the registration procedure for the second IMS.

According to an embodiment, the method may further include, via the second IMS PDN connection, connecting the IMS call.

According to an embodiment of the disclosure, the first SIM may include a designated data subscription (DDS) SIM designated for using mobile data, and the second SIM may include a non-designated data subscription (non-DDS) SIM.

According to an embodiment, the method may further include identifying that the IMS call is terminated.

The method may further include, via the at least one second RF path, releasing the second IMS PDN connection.

According to an embodiment of the disclosure, the method may further include, after releasing the second IMS PDN connection, performing the registration procedure for the second IMS based on the first Internet PDN connection.

According to an embodiment of the disclosure, a radio access technology (RAT) used in the first communication network (e.g., the first communication network 111a in FIG. 1B) may include at least one of a long-term evolution (LTE) technology or a new radio (NR) technology.

The method may further include, before performing the registration procedure for the second IMS based on the first Internet PDN connection, identifying whether a WiFi connection is possible.

According to an embodiment of the disclosure, the method may further include, based on the WiFi connection being possible, performing the registration procedure for the second IMS based on the WiFi connection.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a radio frequency (RF) circuit;
memory, comprising one or more storage media, storing instructions; and
at least one processor communicatively coupled to the RF circuit and the memory,
wherein the instructions, when executed by the at least one processor individually or collectively, cause the electronic device to:
establish a first Internet packet data network (PDN) connection related to a first subscriber identity module (SIM) by performing an attach procedure with a first communication network via at least one first RF path related to the first SIM among a plurality of RF paths supportable in the electronic device, and
based on the first Internet PDN connection, perform a registration procedure with a second Internet protocol (IP) multimedia subsystem (IMS) connected to a second communication network
wherein the first SIM is used for attaching to the first communication network, and a second SIM is used for attaching to the second communication network.

2. The electronic device of claim 1, wherein the instructions, when executed by the at least one processor individually or collectively, further cause the electronic device to:
perform the registration procedure for the second IMS based on an IP address related to the first Internet PDN connection, an IP address of a domain name system (DNS) server, or a radio access technology (RAT) used in the first communication network.

3. The electronic device of claim 1, wherein the instructions, when executed by the at least one processor individually or collectively, further cause the electronic device to:
release a second IMS PDN connection related to the second SIM which is established between the second IMS and the electronic device via at least one second RF path related to the second SIM among the plurality of RF paths.

4. The electronic device of claim 1, wherein the instructions, when executed by the at least one processor individually or collectively, further cause the electronic device to:
release a second Internet PDN connection related to the second SIM which is established between the second communication network and the electronic device via the at least one second RF path related to the second SIM among the plurality of RF paths.

5. The electronic device of claim 3, wherein the instructions, when executed by the at least one processor individually or collectively, further cause the electronic device to:
via the first IMS PDN connection established between the first IMS connected to the first communication network and the electronic device, identify that an IMS call related to the second SIM from the second IMS exits;
via the at least one second RF path, establish the second IMS PDN connection related to the second SIM;
based on the second IMS PDN connection, perform the registration procedure for the second IMS; and
via the second IMS PDN connection, connect the IMS call.

6. The electronic device of claim 1, wherein the first SIM includes a designated data subscription (DDS) SIM designated for using mobile data, and the second SIM includes a non-designated data subscription (non-DDS) SIM.

7. The electronic device of claim 6, wherein the instructions, when executed by the at least one processor individually or collectively, further cause the electronic device to:
identify that the IMS call is terminated; and
via the at least one second RF path, release the second IMS PDN connection.

8. The electronic device of claim 7, wherein the instructions, when executed by the at least one processor individually or collectively, further cause the electronic device to:
after release of the second IMS PDN connection, perform the registration procedure for the second IMS based on the first Internet PDN connection.

9. The electronic device of claim 1, wherein the instructions, when executed by the at least one processor individually or collectively, further cause the electronic device to:
before performance of the registration procedure for the second IMS based on the first Internet PDN connection, identify whether a wireless-fidelity (WiFi) connection is possible; and
based on the WiFi connection being possible, perform the registration procedure for the second IMS based on the WiFi connection.

10. A method of operating an electronic device, the method comprising:
establishing a first Internet packet data network (PDN) connection related to a first subscriber identity module (SIM) by performing an attach procedure with a first communication network via at least one first radio frequency (RF) path related to the first SIM among a plurality of RF paths supportable in the electronic device; and
based on the first Internet PDN connection, performing a registration procedure with a second Internet protocol (IP) multimedia subsystem (IMS) connected to a second communication network related to a second SIM,
wherein the first SIM is used for attaching to the first communication network, and the second SIM is used for attaching to the second communication network.

11. The method of claim 10, wherein, based on the first Internet PDN connection, performing the registration procedure with the second IMS comprises:
performing the registration procedure for the second IMS based on an IP address related to the first Internet PDN connection, an IP address of a domain name system (DNS) server, or a radio access technology (RAT) used in the first communication network.

12. The method of claim 10, further comprising:
releasing a second IMS PDN connection related to the second SIM which is established between the second IMS and the electronic device via at least one second RF path related to the second SIM among the plurality of RF paths.

13. The method of claim 10, further comprising:
releasing a second Internet PDN connection related to the second SIM which is established between the second communication network and the electronic device via the at least one second RF path related to the second SIM among the plurality of RF paths.

14. The method of claim 12, further comprising:
via the first IMS PDN connection established between the first IMS connected to the first communication network and the electronic device, identifying that an IMS call related to the second SIM from the second IMS exits;
via the at least one second RF path, establishing the second IMS PDN connection related to the second SIM;
based on the second IMS PDN connection, performing the registration procedure for the second IMS; and
via the second IMS PDN connection, connecting the IMS call.

15. The method of claim 10, further comprising:
before performing the registration procedure for the second IMS based on the first Internet PDN connection, identifying whether a wireless-fidelity (WiFi) connection is possible; and
based on the WiFi connection being possible, performing the registration procedure for the second IMS based on the WiFi connection.

16. The method of claim 10, wherein the first SIM includes a designated data subscription (DDS) SIM designated for using mobile data, and the second SIM includes a non-designated data subscription (non-DDS) SIM.

17. The method of claim 16, further comprising:
identifying that the IMS call is terminated; and
via the at least one second RF path, releasing the second IMS PDN connection.

18. The method of claim 17, further comprising:
after releasing the second IMS PDN connection, performing the registration procedure for the second IMS based on the first Internet PDN connection.

19. One or more non-transitory computer-readable storage media storing one or more computer programs including computer-executable instructions that, when executed by at least one processor of an electronic device individually or collectively, cause the electronic device to perform operations, the operations comprising:
establishing a first Internet packet data network (PDN) connection related to a first subscriber identity module (SIM) by performing an attach procedure with a first communication network via at least one first radio frequency (RF) path related to the first SIM among a plurality of RF paths supportable in the electronic device; and
based on the first Internet PDN connection, performing a registration procedure with a second Internet protocol (IP) multimedia subsystem (IMS) connected to a second communication network related to a second SIM,
wherein the first SIM is used for attaching to the first communication network, and the second SIM is used for attaching to the second communication network.

20. The one or more non-transitory computer-readable storage media of claim 19, the operations further comprising:
performing the registration procedure for the second IMS based on an IP address related to the first Internet PDN connection, an IP address of a domain name system (DNS) server, or a radio access technology (RAT) used in the first communication network.
